(19) United States
(12) Patent Application Publication
(10) Pub. No.: US 2023/0182056 A1
(43) Pub. Date: Jun. 15, 2023

(54) FLUID FILTRATION SYSTEM AND METHOD OF USE

(71) Applicant: Molekule, Inc., San Francisco, CA (US)

(72) Inventors: Jaspreet S. Dhau, San Francisco, CA (US); Dilip N. Goswami, San Francisco, CA (US); Philip Myers, San Francisco, CA (US); David Sanabria, San Francisco, CA (US)

(21) Appl. No.: 18/104,716

(22) Filed: Feb. 1, 2023

Related U.S. Application Data
(63) Continuation of application No. 16/523,928, filed on Jul. 26, 2019.
(60) Provisional application No. 62/703,808, filed on Jul. 26, 2018.
(60) Provisional application No. 62/782,072, filed on Dec. 19, 2018.

(51) Int. Cl. B01D 46/00; B01D 53/00; B01D 53/04; B01D 53/88; B01D 53/86; B01D 46/52; B01D 46/24

(52) U.S. Cl. CPC B01D 46/0036; B01D 53/007; B01D 53/0407; B01D 53/885; B01D 53/8678; B01D 46/0005; B01D 46/521; B01D 46/2403; B01D 46/0028; B01D 2279/40; B01D 2258/06; B01D 2255/802; B01D 2259/802; B01D 2253/102

(57) ABSTRACT

A fluid filtration system that includes one or more layers, including a trapping layer and a reactive layer, connected to a frame. A method for fluid filtration that includes sorbing contaminants, trapping contaminants, and degrading contaminants.

### CROSS-REFERENCE TO RELATED APPLICATIONS

This application is a continuation of U.S. patent application Ser. No. 16/523,928, filed 26 Jul. 2019 which claims the benefit of U.S. Provisional Application No. 62/703,808, filed 26 Jul. 2018 and U.S. Provisional Application No. 62/782,072, filed 19 Dec. 2018, each of which is incorporated in its entirety by this reference.

### TECHNICAL FIELD

This invention relates generally to the fluid filtration field, and more specifically to a new and useful system and method in the fluid filtration field.

### BACKGROUND

Air filtration systems can be used to remove airborne pollutants such as particulates, volatile organic compounds (VOCs) and bioaerosols from the environment to improve air quality. Typical filtration systems use air filter media that requires changing and/or regenerating after a relatively short duration of use in order to maintain a desired level of pollutant capture efficiency and prevent the media from outgassing previously captured pollutants. For example, activated carbon media found in many air purification systems can become a source of VOCs upon saturation or change in ambient conditions (e.g., temperature, relative humidity, etc.), as gaseous pollutants increasingly fill up the adsorption sites of the activated carbon and/or are desorbed from the filter media. Once the activated carbon bed is saturated, the filter can no longer efficiently trap pollutants. In fact, chemicals with a greater affinity for an adsorption site can displace those with lesser affinity, and the affinity of a given chemical for the sorbent is highly dependent on ambient conditions such as temperature and relative humidity. So, as conditions change, different chemicals may be released from the filter. Conventional filtration systems can also have variable performance across pollutant types, wherein filters selectively adsorb, degrade, or trap different types of pollutants with varying efficiency depending upon their chemical properties and/or other characteristics. Such inconsistencies and deficiencies in conventional filtration systems can result in health risks to users, unacceptably high airborne pollutant levels, unpredictable pollutant removal performance, and other issues.

Thus, there is a need in the fluid filtration field to create a new and useful fluid filtration system and method. This invention provides such new and useful fluid filtration system and method.

### BRIEF DESCRIPTION OF THE FIGURES

FIG. 1 is a schematic representation of a variation of a fluid filtration system.

FIG. 2 is a schematic representation of a variation of the method.

FIG. 3 is a schematic representation of a variation of the method of manufacture.

FIG. 4 is a perspective view of a portion of an example related fluid filtration system into which a variation of the filter media is integrated.

FIG. 5 is a perspective view of a portion of an example related fluid filtration system into which a variation of the filter media is integrated.

FIG. 6 is a cross sectional view of an example of a filter media.

FIGS. 7A, 7B, and 7C are: a schematic representation of a first example of the filter media, a schematic representation of second example of the filter media, and a cross sectional view of a third example of the filter media, respectively.

FIG. 8 is a comparative plot of degradation performance of a plurality of variations of layers of the filter media.

FIG. 9 is an illustration of an embodiment of sorbing contaminants in a variation including activated carbon in accordance with a variation of a portion of a sorbent layer.

FIG. 10 is a cross sectional view of an example of the filter media.

FIG. 11 is a perspective view of a portion of an example related fluid filtration system into which a variation of the filter media is integrated.

FIG. 12 is an illustration of an embodiment of degrading contaminants in a variation including photocatalyst in accordance with a variation of a portion of a reactive layer.

FIGS. 13A and 13B are an illustrative example of the filter and a schematic representation of the example, respectively.

FIGS. 14 and 15 are an isometric and an exploded view of a variation of the fluid filtration system, respectively.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. OVERVIEW

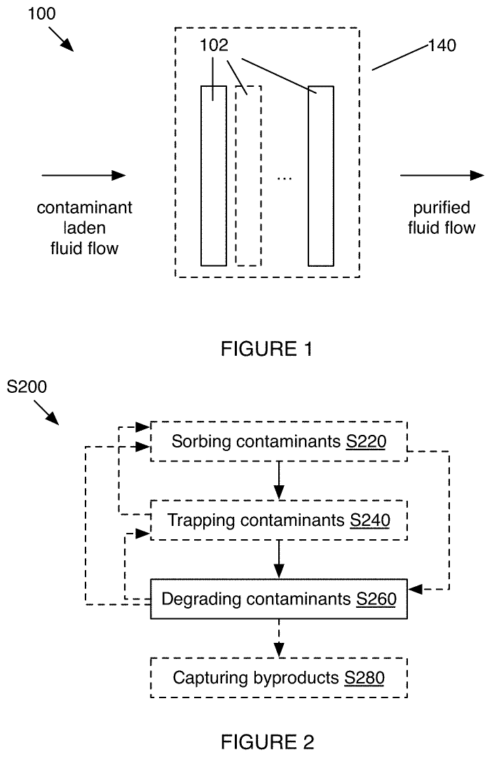

As shown in FIG. 1, the system 100 can include filter media that can include a plurality of filter layers and one or more frames. The plurality of filter layers can include one or more reactive layers and/or one or more trapping layers. The system 100 can optionally include one or more support layers, additional or alternative filter layers, fluid guides, and/or any other suitable mechanisms and/or components for facilitating fluid purification.

The system preferably functions to eliminate airborne contaminants 190 from an air stream. Contaminants 190 can include volatile organic compounds (VOCs); biological contaminants (e.g., bacteria, viruses, mold spores, fungi, etc.); particulate matter such as: soot particles, dust, smoke, particles larger than a predetermined threshold (e.g., 0.3 μm, 1 μm, 3 μm, 10 μm, etc.), etc.; pollutants such as: nitrogen oxides (e.g., NO, NOR, etc.), sulfur oxides (e.g., SO2, SO3, SOₓ, etc.), carbon monoxide, chlorides, ammonia (e.g., NH₃), etc.; volatile inorganic compounds; allergens such as dander, pollen, etc.; and/or any other contaminants that can be found in indoor and/or outdoor airflows. The system can also function to improve the efficiency of fluid filtration over single-layer and/or non-hybridized filtration systems. The system can also function to integrate into existing airflow systems (e.g., HVAC ducting, vehicle ventilation systems, free-standing air purifiers, etc.). However, the system can additionally or alternatively be used to filter aqueous, oil, or other fluid streams and/or have any other suitable function.

In a first variant of the fluid filtration system, the filter media can be mounted in a single, contiguous frame. In a second variant of the fluid filtration system, each of the plurality of filtration layers can be mounted in one or more distinct frame(s) (e.g., distinct from each other, distinct from the filtration mechanism or air purifier, etc.). In a third variant of the fluid filtration system, the filter media includes a single layer possessing each of the functionalities of the filter layers (e.g., single layer that functions as both the reactive layer and the trapping layer).

As shown in FIG. 2, the fluid filtration method S200 preferably functions to remove one or more contaminants 190 from a fluid stream (e.g., fluid flow, fluid flow path, fluid path, etc.). The method can include: sorbing contaminants, trapping contaminants, degrading contaminants, and/or otherwise processing contaminants. The method can optionally include capturing degradation byproducts and/or any other suitable steps and/or processes. The method can be performed by a fluid filtration system; however, the method can be performed by any suitable system.

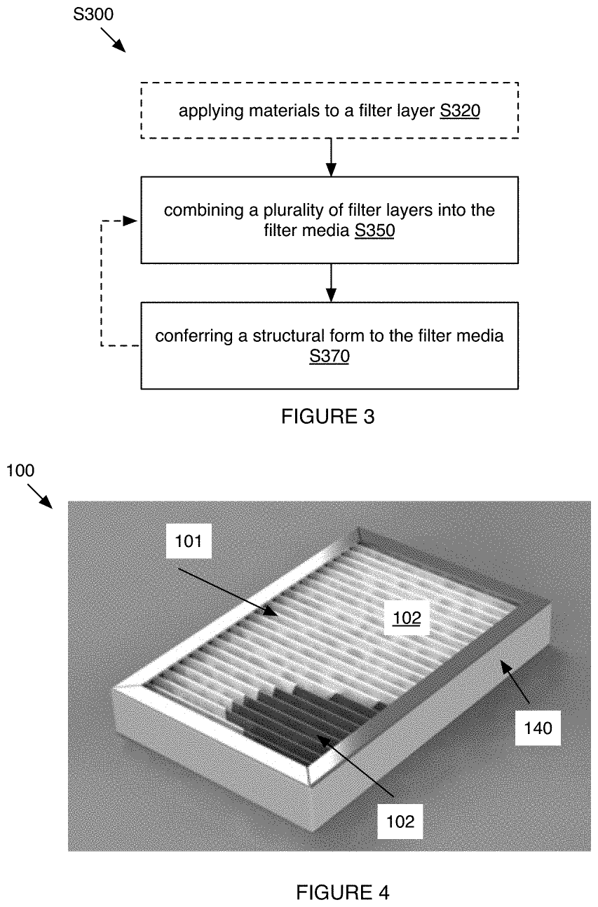

As shown in FIG. 3, a method of manufacture S300 for the filter media can include: applying materials to a filter layer S320, combining a plurality of filter layers into the filter media S350, and conferring a structural form to the filter media S370. The method of manufacture can additionally or alternatively include any other suitable steps and/or subprocesses.

The method of manufacture S300 preferably functions to provide a fluid filtration system 100 substantially as described. The method of manufacture S300 can additionally or alternatively have any other suitable function in relation to manufacturing at least a portion of a fluid filtration system as described herein.

### 2. BENEFITS

Variations of the technology can confer several benefits and/or advantages.

First, variations of the technology can improve the contaminant degradation efficiency of filters that include a photocatalyst without increasing the amount (e.g., concentration, total amount, etc.) of photocatalytic material used. For example, such variations can include a filter media that includes a reactive layer (e.g., coated with photocatalytic nanoparticles) and a trapping layer, such that the filter media includes, in total, the same amount of photocatalytic material as would be applied to a single photocatalytic layer acting alone. The filter media with multiple layers shows improved degradation efficiency (e.g., by increasing dwell time of contaminants in the filter assembly) compared to the single photocatalytic layer, and can also show improved particulate removal efficiency (e.g., by physically filtering contaminants and/or particulates). Such performance is unique and unexpected, as a higher degradation efficiency is achieved without any increase in the photocatalytic material.

Second, variations of the technology can provide broad, less-, or non-selective degradation of contaminants, compared to conventional filtration systems and methodologies that exhibit selectivity and/or may require tuning toward specific contaminants (e.g., chemical compounds). For example, such variations of the technology can adsorb and destroy various VOCs irrespective of conditions, type of functional groups, and/or chemical identity.

Third, variations of the technology can reduce end-user costs by reducing the frequency with which filters require replacement. In conventional filtration systems, replacing saturated filters (e.g., saturated adsorption filters, saturated carbon filters, etc.) can become inconvenient and expensive. It can also be difficult to determine when such a conventional filter should be replaced, as there are often no detectable signs that the filter is substantially saturated, resulting in the use of filters that should be replaced and replacement of filters that remain usable. Variations of the technology can extend the lifespan of saturable filters through combination with other filter layer types (e.g., reactive filter layers, trapping filter layers, etc.) to solve these deficiencies of conventional filtration systems. In another example, a trapping layer can redistribute a peak in the quantity of contaminants (e.g., an increased amount of contaminants at a specific time of day) that reaches a reactive layer to other times of day, thereby preventing the reactive layer from being overloaded and wearing out more rapidly.

Fourth, variations of the technology can remove a set of contaminants that may otherwise require a number of separate conventional filtration systems that are effective for removing a subset of such contaminants. For example, adsorption filters (e.g., activated carbon filters) alone are typically effective at removing many types of organic compounds (e.g., VOCs) from the air, but are relatively ineffective at removing particulate contamination (e.g., allergens like dust and pollen, allergen proteins or other allergens in the air, secondhand or wildfire smoke, PM 2.5 pollution, PM 10 pollution, etc.). Through combination with filter media that trap and/or degrade particulate pollution, variations of the technology can solve such deficiencies of conventional filtration systems.

Fifth, variants of the technology can enable air disinfection and purification by destroying (e.g., degrading, oxidizing, reducing, precipitating, eliminating) contaminants (e.g., instead of or in addition to trapping fully-constituted contaminants).

Sixth, variants of the technology can ensure that contaminants are fully degraded (e.g., by increasing the dwell time of contaminants in the filter media, by loading the reactive layer at or below the reactive layer's degradation capacity, etc.). For example, the use of sorbent layers (e.g., activated carbon) can increase the time that VOCs spend in the filter media. This increased time provides more opportunities for the VOCs to interact with the reactive layer (e.g., photocatalytic layer) and breakdown into byproducts.

Seventh, variants of the technology can increase the amount of light that is available at a photocatalytic layer without changing the light source (e.g., output power, illuminance, etc.). For example, in variants where a light source is arranged downstream of (or distal) the filter media and downstream of (e.g., adjacent to) the photocatalytic layer, when the light source is directed toward the photocatalytic layer and the filter media, and/or when the light source is directed radially outward, other layers (e.g., trapping layers, support layers, etc.) can be suitably arranged to reflect unabsorbed photons back toward the photocatalytic layer, thereby increasing the effective optical flux at the photocatalytic layer without changing the light source.

Eighth, variants of the technology can decrease the amount of light that is released from the filter media. For example, in variants where a light source is arranged downstream of the filter media, the furthest upstream filter layers can be configured to be optically opaque (e.g., to the light source photons; to visible photons; to ultraviolet photons; to near infrared photons; to photoluminescence such as fluorescence, photoluminescence, etc.; etc.) example as shown in FIG. 1i, etc.). This configuration decreases the amount of light that leaks out of the filter, which provides a more pleasing user experience and is safer for users.

Ninth, variants of the technology can be configured so that one layer serves one or more functions. For example, a trapping layer can be coated with sorbants, thereby conferring both particle trapping and sorption at the same layer. In another example, a trapping layer can be reflective to photons, thereby conferring both particle trapping and optical properties at the same layer.

Tenth, variants of the technology can be arranged to control the fluid flow through the fluid filtration system. For example, the layer porosity and/or layer arrangement relative to adjacent layers (e.g., separation distance) can be selected to control eddies, tortuosity, and other properties of the fluid flow through the fluid filtration system. The fluid flow can be controlled, for example, to generate lower inter-layer pressure to pull working fluid through.

However, variants of the technology can confer any other suitable benefits and/or advantages.

### 3. SYSTEM

As shown in FIG. 1, the fluid filtration system 100 can include filter media 101 that includes a plurality of filter layers and one or more frames. The plurality of filter layers can include one or more reactive layers and/or one or more trapping layers. The fluid filtration system 100 can optionally include one or more support layers, additional or alternative filter layers, and/or any other suitable mechanisms and/or components for facilitating fluid purification.

The fluid filtration system preferably functions to eliminate airborne contaminants 190 from an air stream. Contaminants 190 can include volatile organic compounds (VOCs); biological contaminants (e.g., bacteria, viruses, mold spores, fungi, etc.); particulate matter such as: soot particles, dust, smoke, etc.; pollutants such as: nitrogen oxides (e.g., NOₓ), sulfur oxides (e.g., SOₓ), chlorides, ammonia (e.g., NH₃), etc.; allergens such as dander, pollen, etc.; and/or any other contaminants that can be found in indoor and/or outdoor airflows. The system can also function to improve the efficiency of fluid filtration over single-layer and/or non-hybridized filtration systems. The system can also function to integrate into existing airflow systems (e.g., HVAC ducting, vehicle ventilation systems, free-standing air purifiers, etc.). However, the system can additionally or alternatively be used to filter aqueous, oil, or other fluid streams and/or have any other suitable function.

The fluid filtration system is preferably coupled to a fluid flow system (e.g., a filter system) that can include a fluid flow, one or more impeller modules, one or more excitation sources, and/or a support structure; however, the fluid filtration system can alternatively be coupled to any suitable fluid flow and/or fluid flow system.

The fluid flow preferably passes through the fluid filtration system (e.g., radially inward, radially outward, perpendicular to the fluid filtration system surface, at an arbitrary angle relative to the fluid filtration system surface, through an annulus, through the filter thickness, etc.); however, additionally or alternatively, the fluid flow can be substantially parallel to the fluid filtration system (e.g., flow along the fluid filtration system surface, parallel to the center of the fluid filtration system, parallel to a lateral axis of the fluid filtration system, parallel to a longitudinal axis of the fluid filtration system, in an arbitrary direction along the fluid filtration system, etc.), and/or may be otherwise suitably oriented. The fluid preferably uniformly flows into the fluid filtration system (e.g., fluid flow is constant or equal along fluid filtration system surface, the pressure drop approximately the same across the fluid filtration system surface, etc.); however, additionally or alternatively, the fluid flow can be heterogeneous, uncontrolled, partially controlled (e.g., uniform over a subset of the fluid filtration system), and/or any other suitable flow. The fluid flow can be controlled by baffles, eddies, impeller modules, fluid filtration system design, and/or by any suitable components in the fluid flow system and/or the fluid filtration system.

The excitation source preferably functions to activate the fluid filtration system (e.g., the reactive layer). The excitation source can function to degrade one or more contaminants 190 and/or provide any other suitable function. The excitation source is preferably a light source (e.g., light emitting diode, laser, lamp, fluorescent light, etc.); however, additionally or alternatively, the excitation source can be ambient light, a power source (e.g., power supply), a heat source, and/or any suitable source of excitation. The excitation source is preferably immediately adjacent to a reactive layer (e.g., photocatalytic layer, photoelectrochemical layer, photoelectrochemical oxidation (PECO) layer, etc.); however, additionally or alternatively, the excitation source can be immediately adjacent to any suitable layer of the filter media 101. The excitation source is preferably directed toward the reactive layer, but can additionally or alternatively be directed toward another layer (e.g., a reflective layer that reflects light back to the reactive layer, a layer translucent to the excitation wavelengths, etc.). In specific variants, when the fluid filtration system has a cylindrical profile, the excitation source can be arranged within the fluid filtration system (e.g., radially inward, along the center of, within the lumen of, or otherwise arranged within the fluid filtration system, etc.); however, the excitation source can additionally or alternatively be arranged between layers of the fluid filtration system, outside of the fluid filtration system (e.g., radially outward of the fluid filtration system, surround the fluid filtration system, etc.), and/or be otherwise suitably located relative to the fluid filtration system.

In specific variants, the light source is preferably arranged to uniformly illuminate the surface of the fluid filtration system (e.g., illuminate the fluid filtration system with approximately the same power, power variation <5%, <10%, <20%, etc. across the fluid filtration system surface, etc.) proximal the light source. However, additionally or alternatively, the light can be arranged to provide patterned illumination of the fluid filtration system (e.g., regions of the fluid filtration system can receive larger and smaller optical fluence), nonuniform illumination, random illumination, temporally varying illumination, spatio-temporally varying illumination, and/or any other suitable illumination. The light source is preferably configured (e.g., using filters; based on the light source material; based on the light source operation parameters such as temperature, energy, etc.; etc.) to emit UV-A, UV-B, and/or visible optical radiation (e.g., wavelengths in the range 280-700 nm and/or subsets thereof); however, additionally or alternatively, the light source can be configured to emit UV-C (e.g., 100-280 nm), near-infrared (e.g., 700-1400 nm), infrared (e.g., 700 nm to 1 mm), subsets and/or overlapping regions of wavelength ranges, and/or any suitable wavelength.

The fluid filtration system preferably has a form factor that is complimentary (e.g., matches, is the same as, enables coupling, etc.) to the form factor of the fluid flow system (e.g., the support structure, the fluid flow path, the fluid flow design, etc.); however, the fluid filtration system can be noncomplimentary to the fluid flow system (e.g., be different from) and/or have any suitable form factor. The form factor can be cylindrical, hemispherical, planar, hemicylindrical, spherical, prismatoidal (e.g., being shaped like a cuboid, triangular prism, prismoid, etc.), toroidal, ellipsoidal, catenoidal, and/or any other suitable geometry.

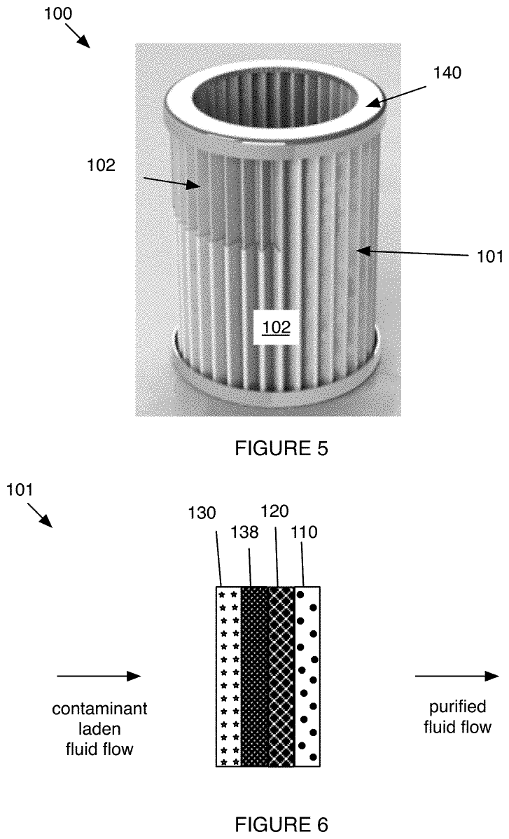

For example, as shown in FIG. 4, the fluid filtration system can be combined into an substantially planar air purification cartridge that can be included in a rectangular ducting system. The fluid filtration can be removably insertable to the ducting system, or be permanently installed. In another example, as shown in FIG. 5, the fluid filtration system can be arranged into a tubular filter cartridge that can be included in a stand-alone air purification system (e.g., for home use, for use in enclosed spaces, etc.). The fluid filtration system 100 can additionally or alternatively be included in any suitable air purification or filtration system in which contaminant-laden air can be passed proximal to (e.g., through, over, adjacent to, etc.) the filter media 101.

### 3.1 Filter Media

The filter media 101 preferably functions to remove one or more contaminants 190 from a fluid stream that flows through the filter media 101, utilizing one or more contaminant removal mechanisms. The filter media 101, for example as shown in FIG. 6, preferably includes a plurality of layers 102, wherein each layer can remove contaminants using one or more pollutant removal mechanisms; however, additionally or alternatively, the filter media 101 can include a single layer (e.g., with one or more pollutant removal mechanisms integrated to the same layer), and/or have any suitable layer configuration. Each layer can be configured and/or formulated specifically in accordance with one or more contaminant removal mechanisms, associated with a “layer type” or “layer class”. Layer types can include: a reactive layer, a precipitation layer, a sorbent layer, a trapping layer, a particle-trapping layer, an inactive layer, a support layer, a chemical layer, and/or any other suitable type of layer. Layers can define various properties, including thickness, porosity (e.g., permeability to fluid flow such as airflow), relative orientation (e.g., versus other layers in relation to fluid flow direction, illumination, etc.), conductivity (e.g., electrical conductivity, thermal conductivity, etc.), and/or any other suitable surface or bulk property.

A broad face (e.g., surface) of the filter media can be pleated, smooth (e.g., flat), folded, ridged, puckered, curved, a mixture of features, and/or the broad face can have any suitable configuration. Preferably, all of the layers of the filter media have the same broad face configuration; however, each of the layers can have different broad face configurations (e.g., different sizes such as different pleating depth, different configurations, etc.), a subset of the layers can have the same broad face configuration, the layers can have a broad face configuration that depends on adjacent layers (e.g., layer type, layer broad face, layer contaminant removal mechanism, etc.), and/or any other suitable layer broad face configuration can be used. In a specific example, the pleating depth (e.g., average peak to trough size of the pleats), can be determined based on (e.g., vary directly or inversely with): filter media size, filter media surface area, the intended application (e.g., airflow filtration, oil filtration, water filtration, office filtration, home filtration, automobile, etc.), fluid flow rate, and/or any other suitable parameter. In examples, the pleating depth can be any depth (or range thereof) between 0.1 cm-50 cm, and/or have any other suitable depth. The pleat density can be: between 1-10 pleats per 100 mm or range thereof, 5 pleats per 100 mm, or any other suitable pleat density.

The thickness of the layers preferably depends on the layer's class and/or type; however, additionally or alternatively, the thickness can be the same for some and/or all of the layers, different for all layers, depend on the fluid flow system (e.g., support structure, fluid flow path, etc.), the intended application, fluid flow rate, and/or may otherwise suitably be determined. In a specific example, the thickness of the layers (e.g., individual layers, stacked layers, etc.) can be any thickness (or range thereof) between: 0.1 mm-10 cm, and/or have any other suitable thickness.

All of the layers in the filter media 102 are preferably porous (e.g., have a porosity); however, additionally or alternatively, the layers can be fibers, honeycombs, isogrids, hollow, open, drilled out, and/or have any suitable geometry or structure to promote fluid flow through the filter media 101 (e.g., flow rate >0 m³/s). All of the layers can have the same porosity or different porosity. The porosity of the layers can function to trap any suitable quantity (e.g., >20%, >35%, >50%, >65%, >75%, >85%, >95%, >99%, etc.) of contaminants of a given size (e.g., 100 pm-10 nm, 0.3-1 μm, 1-3 μm, 3-10 μm, etc.) or range thereof. The layers can be arranged (e.g., oriented) so that the porosity increases or decreases from the innermost layer to the outer most layer, so that the porosity alternates between layers, and/or be otherwise suitably arranged. The layers can have a minimum efficiency reporting value (MERV) rating (e.g., MERV score of 4, 9, 12, 14, 16, 20, etc.); however, additionally or alternatively, the layers can be high-efficiency particulate air (HEPA) rated, ultra-low particulate air (UPLA) rated, not rated, and/or be characterized by any other suitable rating. In examples, the porosity (e.g., void fraction) of the layers can be any porosity (or range thereof) between: 0-1. In examples, the pore size can be any size (or range thereof) between: 100 pm-1 mm, and/or be any other suitable value.

The layers 102 are preferably configured (e.g., suitable porosity, pore size, thickness, material type, etc.) to have a maximum pressure drop of 300 Pa; however, the pressure drop can be any value (or range thereof), between 0-1000 Pa, and/or any suitable value. However, additionally or alternatively, the pressure drop can depend on the fluid flow rate (e.g., through the filter media, through the individual layers, etc.), the total volume of fluid to pass through the filter media, the quantity of contaminants passing through the filter media, the intended application, the fluid flow system, the porosity of adjacent layers, the thickness of adjacent layers, and/or any other suitable characteristics.

The layers are preferably energy (e.g., light) reflective; however, additionally or alternatively, the layers can scatter, absorb, transmit, be transparent, translucent, opaque, and/or otherwise interact with incident energy and/or photons. The light reflectivity can be inherent in the material (e.g., by the layer material, by the layer porosity, etc.), conferred (e.g., by a coating, by an auxiliary layer, layer structure, etc.), and/or achieved by any other means. The layers can be black, white, gray, mirrored, and/or any suitable color and/or shade. In a specific example, the outermost layer in the filter media can be substantially opaque (e.g., blocks 90% or more, 80% or more, 70% or more, etc.) to light (e.g., light with wavelengths or ranges thereof between 100-800 nm, light emitted by the light source, light with wavelengths that activate the reactive layer, etc.). In this example, the outermost layer can be the layer that is furthest from the light source, furthest from the reactive layer, and/or any suitable layer or set of layers. This opacity can function to increase the reactive layer's reactivity (e.g., by retaining the activating energy within the filter media, reflecting the activating energy toward the reactive layer), increase compliance or eye safety (e.g., by lowering the amount of leaked light to regulation-compliant levels), and/or confer any suitable set of benefits. However, additionally or alternatively, the outermost layer can be transparent, translucent, and/or have any other suitable optical properties. In this example, the intermediate and/or inner layers can be transparent to, translucent to, or reflect at least the light emitted by the light source. These properties can function to increase the reactive layer's reactivity (e.g., by redirecting the ingressed photons to other areas of the reactive layer), redirect photons to other reactive layers, or confer other suitable benefits. However, the intermediate layers can be opaque and/or have any other suitable optical properties.

The layers within the filter media 102 are preferably arranged in a stack with one or more adjacent layers. The layers can be coupled along their broad faces, edges, and/or along any suitable portion. The layers are preferably in contact with each other (e.g., contiguous, overlapping); however, additionally or alternatively the layers can have a separation distance between them. The separation distance can be any suitable distance (or range thereof), such as between 0.1 nm-10 cm, and/or be any suitable distance. The separation distance can be the same between layers, depend on adjacent layers (e.g., porosity, type, class, thickness(es), etc.), depend on the fluid flow system (e.g., support structure, fluid flow path, fluid flow rate, etc.), and/or be otherwise suitably determined.

All of the layers are preferably retained within the same housing (e.g., frame 140); however, additionally or alternatively, the layers can be supported in separate frames, a subset of layers can share the same frame, the layers can be supported without a frame, and/or the layers can be retained in any suitable manner. In a specific example, one or more of the layers can be removeable from the frame (e.g., one or more replaceable layers can be mounted to separate subframes that are removeable from a main frame). However, the layers can be permanently attached to the frame, and/or otherwise suitably secured.

The layers are preferably discrete (e.g., separate and distinct from each other); however, additionally or alternatively, the layers can be subsections of a unitary layer and/or otherwise suitably related. The layers can be connected to other (e.g., adjacent) layers by crimping, adhering, soldering, welding, sewing, tying, entangling, bonding (e.g., ionic bonds, covalent bonds, metallic bonds, van der Waals forces, etc.), rolling, indirectly (e.g., through a frame, through a support structure, etc.), and/or by any other suitable means. The layers are preferably affixed to one another along one or more edges (e.g., with the layer broad faces directed toward each other); however, the layers can additionally or alternatively be connected in the center of the broad faces, at corners, in a pattern (e.g., honeycomb, stripes, fixed spacing, lattice, etc.), randomly, etc. All of the layers can be connected in the same manner (e.g., same location, same method, etc.), in different manners (e.g., different locations, different methods, etc.). The method and location of connecting the layers can depend on the layers' types, the layer material, the adjacent layers, the intended application, the fluid flow system, and/or on any other suitable parameters.

Some layers can include a substrate 103 and active material, wherein the substrate 103 provides a surface on which to dispose active material (e.g., the material that performs the function of the layer such as remove contaminants in accordance with the contaminant removal mechanism of the particular layer) and does not necessarily directly or actively contribute to pollutant removal. However, the substrate 103 can function to provide mechanical support to the layer, conduct energy (e.g., electrically, thermally, etc.), perform and/or aid in performance of the contaminant removal mechanism of the layer (e.g., function as a mechanical filter), and/or perform any suitable function. The substrate material can be any suitable material (e.g., a textile material such as felt, wool-fiber-based, synthetic-fiber-based, blended natural and synthetic fibers, etc.; a fibrous fabric media; a non-fibrous fabric media; a metallic surface; metal coated polymer fabric; a polymeric material; a coated polymer; a ceramic media or fabric; a cermet media or fabric etc.). In specific embodiments, the substrate can be electrically conductive (e.g., be loaded with conductive material such as metal nanoparticles, nanowires, wires, polymers, etc.; possess conductive properties; etc.); however, the substrate may be insulating and/or have any other suitable electrical properties.

The active material can be secured to the fibers of a substrate 103 by way of an adhesive, electrostatic attachment, covalent linking, polar covalent bonding, ionic bonding, Van der Waals forces, hydrogen bonds, metallic bonds and/or in any suitable manner.

A reactive layer 110 of the filter media preferably functions to degrade one or more contaminants passing through the filter media (e.g., destroy contaminant molecules, reduce contaminants into constituent molecular blocks or atomic units, deactivating reactive contaminant molecules, etc.). The reactive layer no preferably destroys one or more contaminants using an oxidative process, and more preferably a photo-electrochemical oxidative (PECO) process, but can additionally or alternatively destroy contaminants using a chemical reaction (e.g., combination, decomposition, single displacement, double displacement, combustion, redox, etc.), energy (e.g., electrical discharge such as discharge a large voltage to degrade one or more contaminants for example by ozone generation, direct decomposition; thermal discharge such as heat up the contaminants to above their decomposition temperature, to overcome an activation barrier so that the contaminants can undergo chemical reactions, etc.; etc.), and/or any suitable degradation process (e.g., photochemical oxidation, electrochemical oxidation, catalyzed chemical oxidation, direct ionization, photonic degradation, irradiation, etc.). The reactive layer no is preferably the furthest layer in the filter media downstream of the fluid flow; however, the reactive layer can be the furthest layer in the filter media upstream of the fluid flow, an intermediate layer of the filter media, and/or any suitable location within the filter media and/or relative to the fluid flow. The reactive layer is preferably most proximal to the photon source; however, the reactive layer can be distal to the photon source and/or have any other suitable geographic relationship to the photon source. The reactive layer is preferably adjacent to a support layer; however, the reactive layer can be adjacent to a trapping layer and/or any suitable layer.

In variations, the reactive layer 110 can include a substrate 103 (e.g., such as that discussed above) and a reactive material (e.g., disposed on the substrate).

In a specific example, the substrate is coated on one side with a reactive material (e.g., first side) and is uncoated at the second side. In this example, the substrate can be arranged so that the first side is adjacent to the excitation source and the second side is adjacent to a reflective layer (e.g., trapping layer). However, the first side can be partially occluded from the excitation layer (e.g., by an opaque layer, partially reflective or absorptive layer between the first side and the light source, etc.), and/or configured in any suitable arrangement that allows excitation to reach the reactive layer. However, the second side can be adjacent to the light source, an opaque layer, and/or any suitable layer.

In variations, the active material preferably functions to degrade one or more contaminant molecules (e.g., VOC; inorganic materials such as SO, NOR, CO, etc.; etc.) passing through the filter media (e.g., destroy contaminant molecules, reduce contaminants into constituent molecular blocks or atomic units, deactivating reactive contaminant molecules, etc.); however, the active material can additionally or alternatively degrade nonmolecular contaminants and/or other suitable material. The active material can be disposed on one or more sides of the substrate (e.g., upstream side, downstream side, side proximal to the support material, side opposing to the support material, side adjacent to the light source, side opposing the light source, side proximal trapping layer, side opposing trapping layer, etc.), embedded in the substrate, inherent in the substrate, and/or be otherwise suitably defined. The reactive layer is preferably saturated with the active material (e.g., no more material can be included); however, the active material concentration can additionally or alternatively be unsaturated, any value (or range thereof) between 0.01-1000 g/m², and/or any suitable value of concentration.

The active material can be attached to the substrate by coating, spraying, dipping, electrostatic coating, drop casting, spin coating, evaporating, direct synthesis, weaving, pressing, and/or any other suitable attachment method. The active material distribution preferably substantially uniformly covers the substrate (e.g., active material thickness and/or concentration varies by <90%, <80%, <70%, etc. across the surface of the substrate); however, the active material can be patterned (e.g., to match a patterned excitation source emission), random, nonuniform, and/or otherwise suitably arranged.

In specific embodiments, the reactive layer can be a photocatalytic layer in, where the active material is photocatalytic material, the photocatalytic material 112 functions to provide a catalytic site for direct and/or indirect reduction of contaminants proximal the surface of the substrate of the filter assembly 110. The photocatalytic material 112 can also function to generate an electron-hole pair upon illumination by a photon, which can generate a hydroxyl radical (or other radical) upon interacting with water vapor (or other gaseous contents) contained in the surrounding air (e.g., as part of indirect contaminant reduction). The hydroxyl radical thus generated can chemically react with reducible contaminants in the airflow to chemically reduce the contaminants and thereby eliminate the contaminants from the airflow. The electron-hole pair can also react directly with contaminants in the air (e.g., acting as a free radical), as part of direct contaminant reduction. However, the photocatalytic material 112 can provide any other suitable catalytic or reaction site.

The photocatalytic material 112 is preferably formed at least partially of nanostructures 115, and the nanostructures 115 are preferably formed at least partially from one or more inorganic photocatalysts (e.g., titanium dioxide in anatase, rutile, and any other suitable phase; sodium tantalite; doped titanium dioxide, zinc oxide, any other suitable substance that catalyzes reactions in response to photon illumination, etc.), but can additionally or alternatively be formed from any other suitable material (e.g., carbon, carbon-containing compounds, organic materials, inorganic materials, etc.). The nanostructures 115 preferably include a combination of crushed nanostructures (e.g., crushed nanotubes, crushed nanorods, crushed nanowires, etc.) and nanoparticles (e.g., spherical nanoparticles, quasi-spherical nanoparticles, oblate nanoparticles, etc.). However, the nanostructures 115 can additionally or alternatively include uncrushed nanotubes, crushed and/or uncrushed hollow nanotubes, a homogenous or heterogeneous material made up of any of the aforementioned nanostructures and/or any other suitable nanostructures or combinations thereof in any suitable phase.

The nanostructures 115 of the photocatalytic material 112 can function to induce plasmonic resonance with the illuminating optical frequency or frequencies. The plasmonic resonance frequency of the nanostructures of the photocatalytic material can be based on geometric properties of the nanostructures; in particular, the characteristic dimension (e.g., size) of the nanostructures can correspond to a plasmonic resonance frequency which, in cases where the resonance is excited, increases the efficiency (e.g., quantum efficiency) of the photocatalytic process and enhances PECO performance. In variations, the nanostructures can have size distributions that depend upon the nanostructure type. For example, nanoparticles can have a first size distribution that is narrower than a second size distribution of crushed nanostructures. Crushing the nanostructures can result in a broader size distribution of the resulting crushed nanostructures (e.g., as compared to substantially spherical nanoparticles or nanobeads) due to the random variation in the fracture location of the nanostructures during crushing. The crushed nanostructures that are added to the photocatalytic material can, in variations, be selected as a subset of a total quantity of crushed nanostructures in order to adjust the size distribution of the crushed nanostructures that are used in the system 100 (e.g., by filtering the crushed nanostructures based on size after crushing). Broadening the size distribution can increase the number of nanostructures (e.g., including both crushed nanostructures and nanoparticles) in the photocatalytic material that include a characteristic dimension that overlaps with a corresponding plasmonic resonance frequency. The nanostructures can have any suitable characteristic dimension and/or range of characteristic dimensions (e.g., 1-5 nm, 2-50 nm, 50-500 nm, etc.), which can include a characteristic diameter, characteristic length, characteristic volume, and any other suitable characteristic dimension.

The photocatalytic material 112 can include any suitable photocatalytic nanostructures, combined in any suitable ratio and/or combination. In variations wherein the photocatalytic material 112 includes multiple types of nanostructures, the photocatalytic material 112 can be a homogeneous mix of the multiple types of nanostructures (e.g., wherein the relative density of each nanostructure type is substantially equal at any given location on the substrate on which the photocatalytic material is disposed), a patterned combination (e.g., wherein a first set of regions of the photocatalytic material 112 disposed on the substrate in include substantially solely a first type or types of nanostructure, and a second set of regions include substantially solely a second type or types of nanostructure; wherein a first set of regions include photocatalytic material and a second set of regions are devoid of substantial amounts of or any photocatalytic material; etc.), or any other suitable combination. In a specific example, the photocatalytic material 112 is made up of a homogeneous combination of crushed nanorods and nanobeads, in a 1:9 ratio of the nanorods to nanobeads (e.g., 1:9 by mass, 1:9 by volume, etc.). In another example, the photocatalytic material 112 is made up of pure crushed nanorods. However, the photocatalytic material 112 can be otherwise suitably made up of any suitable combination of crushed and/or uncrushed nanostructures. In examples, the reactive layer can include the layers disclosed in U.S. application Ser. No. 16/161,600 filed 16 Oct. 2018, U.S. Pat. No. 9,899,221 filed 2014, 10 Oct. 2014, and/or U.S. Pat. No. 7,635,450 filed 26 Apr. 2016, each of which is incorporated herein in its entirety by this reference. However, the reactive layer can be otherwise constructed.

In specific embodiments, the reactive layer can be a chemical layer 118 that functions to undergo a chemical reaction with one or more contaminant molecules (e.g., SOx, NOx, CO2, VOCs, etc.) to remove contaminant molecules from the fluid flow. However, additionally or alternatively, the chemical layer can react with nonmolecular contaminants. The chemical layer 118 can include solvent with dissolved salt (e.g., metal hydroxides dissolved in water), solid salts, acids, bases, metals, organic molecules, zeolites, metal organic frameworks (MOFs), amines, mixtures of materials, etc. In variants including a chemical layer and a photocatalytic layer, the chemical layer is preferably downstream from the photocatalytic layer in the fluid flow; however, the chemical layer can be upstream, intermixed with the photocatalytic layer, and/or in any suitable location. In a specific example, to capture acidic contaminants from the fluid flow (e.g., SO, NOR, etc.), the chemical layer can be an alkaline earth salt (e.g., Ca(OH)₂, Sr(OH)₂, Ba(OH)₂, etc.) dissolved in water. As the acidic contaminants flow through the chemical layer, they are neutralized by the base and precipitate out of solution. However, any other suitable reaction or mechanism for sequestering the materials can be used.

In additional or alternative variations, the reactive layer can be otherwise suitably configured to degrade contaminants.

The filter media can optionally include a support layer 120. The support structure functions to substantially rigidly retain the filter media and/or a subset of the layers. The support structure can also function to enhance the conductivity and/or electron mobility of the substrate on which the reactive material is disposed (e.g., in cases wherein the support structure is electrically conductive and in contact with the reactive layer), which can function to increase the electron-hole pair lifetime and thus the efficiency of radical creation (e.g., and resultant pollutant reduction).

The support layer 120 is preferably arranged upstream from and directly coupled (e.g., immediately adjacent to, touching, in electrical contact with, etc.) to the reactive layer; however, the support layer can be downstream from the reactive layer, indirectly coupled to the reactive layer, not coupled to the reactive layer, and/or have any suitable configuration. The reactive layer is preferably arranged between the light source and the support layer 120; however, the support layer can be proximal the light source, distal the light source, and/or otherwise suitably configured. The support layer is preferably downstream from the trapping layer; however, the support layer can be upstream from the trapping layer. In a specific example, the support layer is immediately between a particle-trapping layer and the reactive layer; however, the support layer can be otherwise suitably located.

The support layer 120 can be distinct from, integrated into, and/or be the same as the reactive layer substrate, and/or have any other suitable relationship to the reactive layer substrate. The support layer preferably extends over the entire broad face of the reactive layer; however, the support layer can extend over a portion of the broad face, along the edge, over the center, and/or over any suitable area of the reactive layer. In an example, the support layer can be adhered to, rolled to, retained (e.g., by the frame 140), or otherwise attached to the reactive layer.

The support layer material is preferably inorganic, more preferably metal (e.g., aluminium; steel such as stainless, carbon, etc.; magnesium; titanium; etc.); however, additionally or alternatively, the support layer can be include polymers, alloys, fabrics, ceramics, organic materials, etc. The support layer preferably conducts electricity; however, the support layer can alternatively be electrically insulating or have any suitable electrical properties. The support layer is preferably arranged in a mesh (e.g., honeycomb, grid, lattice, etc.); however, the support layer can additionally or alternatively be wires, flexible metal, and/or have any suitable configuration.

In a specific example, the support layer can include a conductive material placed adjacent to the reactive layer substrate to provide both structural support and enhanced surface conductivity. In examples, this conductive material can include a metallic mesh (e.g., aluminium honeycomb) arranged at a surface of the reactive layer substrate; the support layer can be at an opposing side of the reactive layer substrate to the side illuminated by the photon source (e.g., light source), but can additionally or alternatively be between the substrate and the photon source.

In a specific embodiment of the technology, the support layer is internal to the reactive layer substrate. In a first example of this embodiment, the support layer includes a wire mesh of the reactive layer substrate and integrated into the reactive layer substrate, that enables the reactive layer substrate to be pliantly formed into any suitable shape and to hold the shape by way of the rigidity of the wire mesh. In a second example of this embodiment of the technology, the support layer includes conductive and ductile fibers integrated into the substrate, wherein the reactive layer substrate is at least partially formed from fibers that make up a fibrous media, that enables the reactive layer substrate to be formed into a shape utilizing the ductility and partial stiffness of the conductive and ductile fibers (e.g., metallic fibers) integrated therein.

The filter media preferably includes one or more trapping layers 130 of the same or different types that function to capture one or more contaminants. The trapping layer(s) 130 can additionally or alternatively slow contaminant(s) travel through filter media, increase contaminant dwell time in the filter media, capture a subset of the contaminants, and/or otherwise suitably impact the contaminant progress through the filter media. The trapping layer(s) 130 can additionally or alternatively function to provide mechanical support to other layers and/or perform any suitable function. The trapping layer can use chemical, mechanical, electrical, sequestration, entrainment (e.g., liquid entrainment), and/or any other suitable mechanism to capture and/or slow contaminants.

The trapping layer 130 is preferably arranged upstream from the support and reactive layers, and arranged proximal or adjacent to the support layer; however, the trapping layer can be between the support and reactive layer, downstream or distal from the support and reactive layers, and/or otherwise suitably arranged. However, the trapping layer can be adjacent to the reactive layer, oppose the reactive layer (e.g., across the support layer), interleaved between other layers, and/or otherwise located within the filter media stack.

The trapping layer 130 preferably has a higher MERV score than the reactive layer (e.g., trapping layer MERV rating 16 for reactive layer MERV rating 12); however, the trapping layer can have a lower MERV rating than the reactive layer, have the same MERV rating as the reactive layer, not have a MERV rating, not depend on the MERV score of the reactive layer, and/or have any other suitable rating and/or porosity.

In variants of the filter media with more than one trapping layer, the different trapping layers can be configured (e.g., have different porosity, pore sizes, materials, etc.) to trap different subsets (e.g., kinds) of contaminants from the fluid, provide serial filtration (e.g., to prevent the reactive layer from being overloaded and/or clogged), and/or be otherwise suitably used. However, a single trapping layer can be used.

The trapping layer preferably captures most (e.g., >50%, >80%, >90%, >95%, >99%, etc.) of the target contaminant(s) within the working fluid (e.g., fluid flow). In a first example, the trapping filter captures most of the contaminants (e.g., entrained contaminants within the filter media) with a given size range (e.g., 0.3 μm-1 μm, 3 μm-5 μm, 3-10 μm, 0.1 nm-300 nm, 0.3 μm-5 um, etc.); however, additionally or alternatively, the trapping filter can capture contaminants without regard to size. In a second example, the trapping filter can capture a predetermined amount of a subset of contaminants (e.g., 10%, 25%, 40%, 50%, 75%, 90%, etc.) and/or any suitable amount of contaminant(s).

The trapping layer(s) can include one or more: particle-trapping layers 138, sorbing layers (sorbent layers) 133, auxiliary reactive layers (e.g., chemical layer, precipitation layer, etc.), and/or any other suitable layers.

A particle-trapping layer 138 preferably functions to trap particulate contaminants (e.g., contaminants with size grater than a specified range such as: >0.3 μm, >1 μm, >3 μm, >5 μm, >10 μm, etc.), and in particular can function to trap particulates that are not easily or feasibly sorbed and/or degraded by other layers of the filter media. The particle-trapping layer can irreversibly trap contaminants, reversibly trap contaminants, or otherwise trap the contaminants. The particle-trapping layer 138 can also function to enable downstream layers to have a higher porosity (e.g., permeability), lower MERV rating, and/or surface area, by removing the requirement of such downstream layers to trap particulates in addition to other functional responsibilities (e.g., degradation, sorption, etc.). The particle-trapping layer can also function to provide mechanical support for other layers (e.g., other trapping layers such as sorbing layers; other layers in the filter media, etc.) and/or perform any other suitable function. The particle-trapping layer can be a passive layer (e.g., a passive porous layer that is permeable to air and molecular-scale contaminants but traps larger scale contaminants such as micron-scale particles) and/or an active layer (e.g., wherein the trapping efficiency can be actively adjusted via electrostatic charging or similar techniques).

A particle-trapping layer 138 is preferably arranged between other trapping layers and a support layer; however, additionally or alternatively, the particle-trapping layer can be the layer furthest upstream, furthest downstream, oppose a light source relative to a reactive layer, partially occlude a reactive layer from a light source (e.g., be between the reactive layer and light source), and/or have any suitable configuration. In a specific example, the particle-trapping layer is the furthest upstream and/or most distal the reactive layer. Adjacent to the particle-trapping layer is a support layer, and adjacent to the support layer is a reactive layer. However, the layers can be otherwise suitably arranged.

The particle-trapping layer 138 is preferably configured to reflect optical radiation (e.g., light emitted by a light source, light with wavelengths that can excite the reactive layer, etc.); however, additionally or alternatively, the particle-trapping layer can absorb light (e.g., include a coating), transmit light, scatter light, and/or have any suitable optical properties. In a specific example, the particle-trapping layer is configured to scatter (e.g., reflect) optical radiation comprising wavelengths of 280-700 nm, with a wavelength of 280 nm or higher, with a wavelength of 700 nm or lower, and/or any other suitable wavelength. However, the particle-trapping layer can be configured to have any suitable response to any suitable wavelength.

The particle-trapping layer 138 preferably has the highest MERV score of any layers within the filter media (e.g., MERV 14, MERV 16, and/or any suitable MERV rating); however, alternatively or additionally, the particle-trapping layer can have the lowest MERV rating within the filter media, not be rated, can be rated on a different scale (e.g., ISO 16890), and/or any other suitable rating. In a specific example, the reactive layer has a MERV rating of 12 while the particle-trapping layer has a MERV rating of 16. However, both the particle-trapping layer and reactive layer can have any suitable MERV score. In another specific example, the MERV rating of the reactive layer is 16, therefore no particle-trapping layer is included. However, any suitable layer can have a high MERV rating, more than one layer can have a high MERV rating, a particle-trapping layer can be included regardless of the layers present in the filter media, and/or the layers' particle capture efficiency can be otherwise suitably determined.

The particle-trapping layer is preferably made of a polyethylene blend; however, additionally or alternatively, the particle-trapping layer can be made of any suitable substrate material, and/or be made of any suitable material.

In a specific example, the particle-trapping layer can be a passive trapping layer (e.g., no moving parts, no engineered modification to the layer with time, etc.). In this example, the particle-trapping layer can be a HEPA filter, a semi HEPA filter, a ULPA, and/or be any suitable filter class. In this example, the particle-trapping layer is characterized by a porosity, pore size, filter configuration, etc. to trap contaminants with a size (or range thereof) between 0.3-10 μm, and/or capture any suitable size contaminants. However, the passive particle-trapping layer can be otherwise suitably determined.

In a first example of a variation, the particle-trapping layer can be an active trapping layer (e.g., electrostatic). In such variations, the layer is electrostatically charged in order to attract particulates via electrostatic attraction. Such variations enable the particle-trapping layer to define a higher porosity (e.g., greater permeability) versus a passive layer, because additional trapping occurs (e.g., beyond the mechanical filtration of the layer) due to the electrostatic attraction between the charged layer and contaminant particles. Additionally or alternatively, active electrostatic charging can be applied to any suitable layer type to enhance the particle-trapping performance of the layer (e.g., such that an sorbent layer, reactive layer, or uncoated layer acts as an active particle-trapping layer as well). In some examples, the layer can be held at a constant charge; in alternative examples, the layer can be dynamically charged and discharged (e.g., to cycle the particle trapping capacity, refresh the filter layer, etc.).

In a second example of a variation, the particle-trapping layer can be an active trapping layer (e.g., mechanically actuated). In such variations, the layer can be moved (e.g., whipped, jiggled, swayed, vibrated, etc.). Such variations enable the particle-trapping layer to define a higher porosity (e.g., greater permeability) versus a passive layer, because additional trapping occurs (e.g., beyond the mechanical filtration of the layer) over the effective arc that the particle-trapping layer sweeps. In some examples, the active particle-trapping layer can be held at a constant position; in alternative examples, the layer can be dynamically moving with varying frequency, movement patterns, etc. In this specific example, the endpoints of the filter material are preferably fixed while the filter material is moved; however, the endpoints may move as well (e.g., synchronously, asynchronously, etc.). In an example, the filter material can be actuated in a similar manner as that disclosed in U.S. application Ser. No. 16/165,975 filed 19 Oct. 2018, incorporated herein in its entirety by this reference; however, the filter material can be otherwise actuated.

A sorbent layer 133 functions to trap volatile molecular compounds (e.g., VOCs; volatile inorganic materials such as SOx, NOx, CO, etc.; volatile elements; etc.) via a sorption process. In variations, the sorbent layer can function as a buffer or capacitor that increases the dwell time of one or more contaminants in the filter media, which can increase the probability of the contaminant reaction with the reactive layer. The sorbent layer can also function as a chemo-physical buffer layer that retains contaminants (e.g., via adsorption at adsorption sites, absorption, etc.) and subsequently desorbs the contaminants at a slower rate (e.g., for degradation by a downstream reactive layer), such that temporary increases in contaminant concentration (e.g., higher than a maximum concentration than can be degraded by a reactive layer) do not reduce the overall filtration capacity or efficiency of the filter media. In variants, the fluid filtration system can include one or more sorbent layers (e.g., in series, in parallel, etc.), which can increase the sorbing capacity and/or efficacy (e.g., for one or more contaminants) and/or confer any suitable benefit. However, the sorbent layer can serve any other function.

The sorbent layer 133 preferably captures contaminants smaller than a specified size (e.g., molecules, material smaller than 1 nm, 10 nm, 100 nm, 0.3 μm, 1 μm, 5 μm, etc.); however, additionally or alternatively, the sorbent layer can capture contaminants of any suitable size. The sorbent layer preferably captures a predetermined set of contaminants (e.g., those with specific active sites and/or side chains, organic compounds, inorganic compounds, etc.); however, additionally or alternatively, the sorbent layer can capture any suitable contaminant(s).

The sorbent layer 133 preferably adsorbs contaminants (e.g., physisorbs, chemisorbs, etc.); however, additionally or alternatively, the sorbent layer can absorb, react with, precipitate, and/or interact with contaminants in any suitable manner. The sorbent layer more preferably reversible sorbs contaminants; however, the sorbent layer can irreversibly sorb contaminants. In variants, the sorbent layer can reach an equilibrium between the sorbed contaminant and the contaminant in the fluid. As the amount of contaminant in the fluid changes (e.g., is broken down at the reactive layer, fluctuates such with time of day, etc.), the equilibrium can shift. For example, when the contaminant concentration in the fluid is high, more contaminant can be sorbed by the sorbent layer. In another example, when the contaminant concentration in the fluid is low, sorbed contaminant can be released from the sorbent layer (e.g., to be degraded and/or broken down by the reactant layer). However, the sorbent layer can capture contaminant(s) in any suitable manner.

The sorbent layer 133 preferably defines a thickness (e.g., 100 nm, 1 μm, 10 μm, 100 μm, 1 mm, etc.) and/or sorbent loading (e.g., concentration of sorbent such as 1 g/m², 100 g/m², 100 g/m², etc.; sorbent coverage; etc.) that corresponds to a desired dwell time (e.g., 30 s, 5 min, 15 min, 1 hour, 2 hours, 6 hours, 24 hours, etc.) of the contaminant-laden fluid within the layer(s) as it passes through the filter media; however, the sorbent layer thickness and/or sorbent loading can be determined based on sorbent capacity (e.g., how much of a given contaminant(s) the sorbent layer can capture), sorbent lifetime (e.g., how long does it take for the sorbent to degrade), sorbent material, be a predetermined quantity, sorbent layer physical properties (e.g., structural integrity, weight, malleability, opacity, pressure drop, etc.) and/or be otherwise suitably determined. In examples, the thickness can be any thickness (or range thereof) between 0.1 mm-10 cm, or have any suitable thickness. In examples, the sorbent loading (e.g. concentration), can be any density (or range thereof) between 0.01 mg/mm²-1 g/mm², and/or have any suitable surface coverage.

The sorbent layer 133 is preferably the furthest most layer upstream in the fluid flow; however, the sorbent layer can be the furthest downstream, and/or be located at any suitable location in the filter media (e.g., along the fluid flow path). The sorbent layer is preferably the layer most distal the reactive layer, however, additionally or alternatively, the sorbent layer can be proximal the reactive layer, arranged between a particle-trapping layer and the reactive layer, and/or be otherwise suitably arranged within the filter media stack.

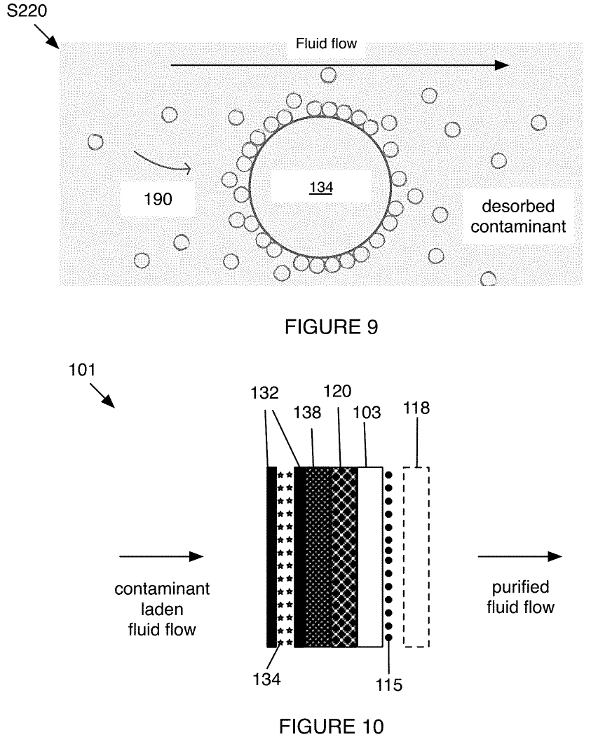

The sorbent material can be activated carbon 134, ceramics, clay, metal-organic-frameworks (e.g., MOFs), zirconium titanate (e.g., ZrTiO₄), zeolites, gels (e.g., silica gels, aerogel, etc.), lead zirconate titanate (e.g., PbZrTiO₄, PZT, etc.), and/or any other suitable material. In variants, the sorbent layer can include activated carbon 134. In some examples, the layer can be entirely or nearly entirely made up of activated carbon, whereas in alternative examples the layer can include a substrate that is not activated carbon (e.g., a fabric layer, one or more scrims, etc.) and a functional material disposed on the substrate that includes activated carbon (e.g., activated carbon particles as shown in FIG. 9, activated carbon impregnated fibers integrated into the fabric, etc.). In such variations, the carbon can be activated such that it defines an sorption efficiency peak, which can be tuned to specific applications (e.g., wherein the sorption efficiency peak is tuned to have high efficiency for chemicals known to exist in relatively high concentrations in the environment in which the filter media is intended to be used). For example, the activated carbon can be tuned (e.g., surface area modified, surface functionalization, etc.) to efficiently adsorb specific chemicals known to exist at high concentrations in the airborne environment proximal a petroleum refinery, or for chemicals known to exist in large proportion in wildfire smoke, cigarette smoke, and/or similar contexts. However, in additional or alternative variations of the sorbent layer including activated carbon, the activated carbon can be untuned (e.g., wherein the sorption efficiency spectrum is substantially flat, wherein the sorption efficiency spectrum includes peaks that are not intentionally adjusted, etc.).

In another variant, the sorbent layer can include activated carbon pellets, wherein the size of the pellets depends on the shape and form factor of the filter media; however, the size of the pellets can additionally or alternatively depend on the physical properties of the activated carbon, the manufacturing process, be independent of the shape and/or form factor of the filter media, be any suitable size (or range thereof) between 1 μm-100 mm, and/or be any suitable size. The pellets are preferably distributed (e.g., uniformly, nonuniformly) across the surface or face of the sorbent layer, but can additionally or alternatively be otherwise arranged. However, additionally or alternatively, the sorbent layer can include carbon fibers (e.g., porous, filled, etc.), hollow tubes, tortuous pores, and/or any other suitable material.

The sorbing layer can be passively and/or actively controlled (e.g., by controlling temperature, fluid flow rate, pressure differentials, etc.). In actively controlled variants, the sorbing layer can include a release element that can function to facilitate the release of sorbed material and/or serve any suitable function. The release element can include a heating element, an electrical element, a pressure element, a compressing/extension element, and/or any suitable element.

In variants, the sorbent layer can include one or more substrates and a active material (e.g., reactive material, including sorbent material). The one or more substrates (e.g., fabric layer, scrim, etc.) can function to provide mechanical support to the sorbent layer and act as material that the active layer can be disposed on. For example, the sorbent layer can include a first and second substrate, with the active material disposed therebetween. However, the active material can be directly applied to another layer (e.g., the reactive layer, the particle-trapping layer, the support layer, etc.) and/or to any suitable material. The scrim(s) can be woven fabric, plastic, polymer, metal, leather, nonwoven fabric, the same as the substrate, the same as the support structure, fiberglass, etc. The substrate(s) is preferably optically opaque (e.g., black, thick, etc.); however, additionally or alternatively, the substrate(s) can be opaque to light source wavelengths, opaque to visible wavelengths (400-700 nm), opaque to subset of visible wavelengths (e.g., 400-450 nm, 400-500 nm, 500-700 nm, etc.), opaque to photoluminescence (e.g., from photocatalytic material, fibers, fluorescent molecules, fluorescent contaminants, fluorescence, phosphorescence, etc.), transparent, semi-transparent, any other suitable optical properties. However, the substrate(s) can have any other suitable properties.

In a specific example of the variant, the sorbent layer can include two scrims 132. At least one of the scrims functions as a substrate for an activated carbon active layer to be disposed upon. The other scrim sandwiches the activated carbon (e.g., forms a structure wherein the activated carbon is located between the two scrim layers) to protect the activated carbon. However, the sorbent layer can be otherwise suitably defined.

In a first variant of the filter media, the sorbent layer can be the furthest upstream layer within the filter media. In this variant, the sorbent layer can include activated carbon and can reversibly capture contaminant(s) as they pass through the filter. The sorbent layer can slowly release the captured contaminant(s), decreasing the instantaneous contaminant(s) load on other filter layer(s). However, the sorbent layer can be otherwise suitably configured.

In a second variant of the filter media, the sorbent layer can be the furthest downstream layer within the filter media. In this variant, the sorbent layer can include a MOF and can reversibly capture carbon dioxide (e.g., CO₂) before it is released from the filter. The sorbent layer can capture CO₂ until the sorbent layer is saturated (e.g., cannot sorb any more CO₂), regenerated (e.g., CO₂ is released from the sorbent layer for example using a release element), and/or any other suitable action occurs and/or is taken. However, the sorbent layer can be otherwise suitably configured.

In a third variant of the filter media, the sorbent layer can optionally include a precipitation layer. As the fluid passes over the precipitation filter, contaminants can condense on the precipitation filter if the precipitation filter is below the condensation point for the material. The precipitation layer can alternatively and/or additionally function to precipitate contaminants from the fluid flow onto the layer to trap the contaminant precipitates. The precipitation layer can also function to convert acidic inorganic gases to salts that are disposed upon (e.g., trapped by) the surface of the precipitation layer. The precipitation layer can also function to trap acidic inorganic gases (e.g., NOx, SOx, CO, etc.) via a metathetical or a single replacement reaction. However, the sorbent layer and precipitation layer can otherwise suitably form contaminant precipitates to remove suitable contaminants from the airflow.

In additional or alternative variations, the sorbent layer can be otherwise suitably configured to adsorb molecular contaminants.

In a first specific example, the filter media can include sorbent layer that includes activated carbon upstream of a reactive layer that includes photocatalytic material. In this example, the activated carbon is activated to define broad spectrum sorption (e.g., wherein the reactive layer eliminates contaminants that desorb or do not sorb due to low relative efficiency) without particular selectivity for specific contaminants; however, in alternative examples, the activated carbon of the sorbent layer can be tuned to selectively adsorb particular contaminants (e.g., contaminants that have a relatively low degradation efficiency).

In a related specific example, the filter media can include a fabric substrate that includes activated carbon particles and photocatalytic nanoparticles disposed thereupon. Such an example and related configurations can be referred to as including a plurality of layers, wherein a single layer performs a plurality of contaminant-removal functions (e.g., sorption and degradation).

In another related example, the filter media includes a number of layers of carbon media and other sorbing layers and a final reactive layer that includes PECO functionality. Alternatively, the final layer can be any other suitable material and/or perform any other suitable filtration and/or contaminant reduction purpose. One or more layers of this example can include a chemical coating to improve sorption or neutralization (e.g., de-activation) of some airborne chemicals.

The filter media of the aforementioned examples can preferably sorb and destroy (e.g., degrade, breakdown, etc.) various VOCs irrespective of conditions and type of functional groups. For example, the upstream sorbent layers can sorb VOCs initially and slowly (e.g., at a reduced kinetic rate) release (e.g., desorb) VOCs, and the PECO media can degrade the released VOCs into benign (e.g., non-harmful, non-polluting) CO₂ and H₂O. In such examples, the carbon and other sorbing media can avoid saturation during operation and also avoid the release of undesirable sorbed chemicals back into the environment.

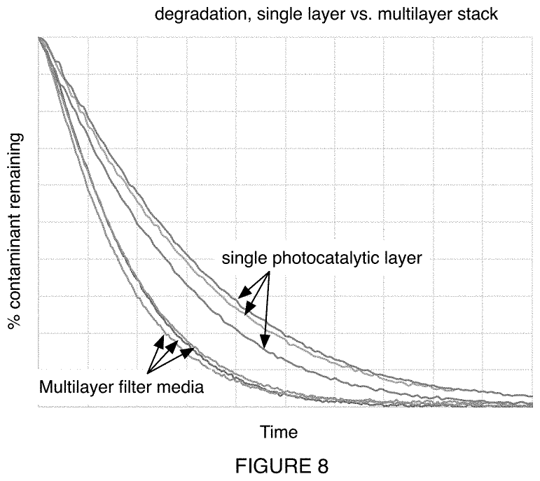

In variations, the reactive layer can include one or more uncoated layers (e.g., substrate(s), particle-trapping layer(s), support layer(s), etc.) in proximity thereto (e.g., adjacent to upstream, adjacent to downstream, adjacent to upstream and downstream, etc.). Such uncoated layers can function to increase dwell time of degradable contaminants proximal the reactive layer (e.g., wherein the reactive layer can be coated in photocatalytic nanoparticles), and thereby increase the overall contaminant degradation efficiency without increasing the amount of photocatalytic material beyond that included in the reactive layer. In examples, the resulting combination of coated and uncoated media can have a VOC degradation efficiency that is increased (e.g., as shown in FIG. 8) versus the corresponding single layer assembly with the same amount of photocatalyst loading (e.g., photocatalytic material disposed on or within the filter media as a whole). In another variation, the uncoated media can be electrostatically charged to achieve improved particle and bioaerosol reduction efficiency (e.g., by way of particle trapping, such that the uncoated layer functions as a particle-trapping layer). In another variation, the reactive layer can be electrostatically charged to increase the residence time of contaminant molecules (e.g., and thereby increase their destruction rate and/or efficiency). In another variation, both the uncoated layer and the photocatalytic layer can be electrostatically charged to improve the particle filtration (e.g., particle trapping) as well as photocatalytic destruction of the contaminants (e.g., VOCs, microbes, etc.).

In another specific example, the filter media includes a particle-trapping layer upstream of a reactive layer. In another specific example, the filter media includes a particle-trapping layer, a sorbent layer, and a reactive layer, wherein the particle-trapping layer is upstream of the sorbent layer and the sorbent layer is upstream of the reactive layer. In another specific example, the filter media includes a particle-trapping layer upstream of a sorbent layer.

However, in additional or alternative examples, the filter media can include any suitable number of any suitable layers in any suitable order.

### 3.2 Frame

The frame 140 preferably functions to provide structural support to the filter media, provide a mounting point for the layers, and/or retains all or a subset of the layer(s) of the filter media in a given order/orientation. However, the frame can serve any suitable function. The frame 140 is preferably connected to the filter media and more preferably connected to all of the layers of the filter media; however, additionally or alternatively, a subset of the layers can be connected to the frame, a single layer can be connected to the frame, the filter media can be self-supported (e.g., no frame is necessary), and/or the frame can be otherwise suitably configured.

The frame is preferably coupled to the top and bottom of the filter media (example shown in FIG. 15); however, additionally or alternatively, the frame can be coupled to only the top, only the bottom, along a length of the layer, around one or more layer edges (e.g., within the layers extending across the lumen defined by the frame), enclosing the layers, and/or by otherwise suitably coupled.

The frame can be metal (e.g., aluminum, stainless steel, carbon steel, etc.), plastic, fabric (e.g., woven, unwoven, etc.), leather, wood, cardboard, and/or any other suitable material. The frame can be adhered, brazed, fitted, stamped, crimped, clamped, screwed, laminated, and/or otherwise suitably affixed to the filter media.

In variants, the frame can include subframes that are removeable from the frame. In these variants, the subframes can be connected to one or more layers of the filter media to provide removeable layers (e.g., particle-trapping layer, sorbent layer, reactive layer, etc.). The subframes can function to facilitate removal and replacement of layers of the filter media without requiring the whole filter media to be replaced at the same time. However, layers can be permanently connected to the frame, semipermanently connected, and/or be connected in any suitable manner.

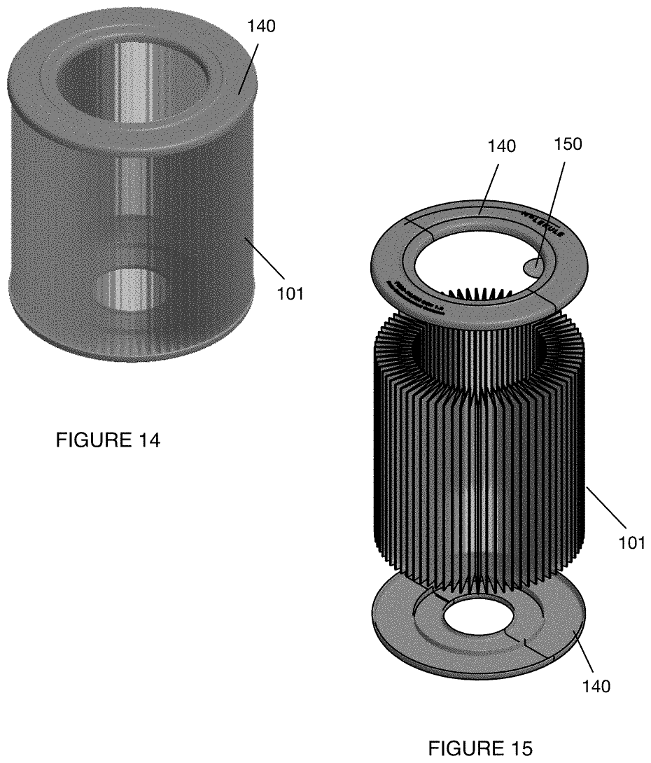

In a specific example, the frame can include two circular or annular subframes (examples shown in FIG. 14 and FIG. 15), each subframe including a cutout. The filter media can be inserted into the cutouts, with one circular frame arranged at a top of the filter media and one arranged at a bottom of the filter media, such that the filter media is held in a cylindrical geometry by the subframes. However, a single subframe can be used and/or any suitable coupling mechanism and/or geometry can be used.

In another specific example, the filter media can define a rectangular broad face. The frame can then be a rectangle (e.g., made of cardboard) that partially and/or fully surrounds the edge of the filter media. The frame can enclose part of the filter media, touch the filter media (e.g., define a cutout region that matches the size of the filter media), and/or be arranged with the filter media in any suitable manner. The frame can function to retain the filter geometry, can provide a handle to manipulate the filter media with, and/or perform any suitable function. However, the frame can be otherwise suitably defined.

The system can optionally include one or more short-range communication systems 150 that function to communicate data to proximal computing systems (e.g., scanners, smartphones, the receiving air filter system, etc.). The short-range communication systems can optionally receive data from the computing systems. The short-range communication system can function to communicate system data, such as: a unique system identifier (filter ID); system age (e.g., system manufacturing date, system ship date, system expiration date, etc.); and/or any other suitable data. The system data can be used to (e.g., by the receiving device, a remote computing system, etc.): track the system, identify the system, verify that the system is authentic (e.g., prior to air filter system operation), track the environmental footprint of the device, track the device metrics (e.g., associate the measured, calculated, or estimated amount of filtered or destroyed contaminants with the system/filter), automatically prompt air filter replacement, automatically generate notifications for users or management entities (e.g., to replace the filter, to not go outside due to poor air quality, etc.), or otherwise used.

The short-range communication system is preferably passive (e.g., powered by an externally-applied RF field), but can additionally or alternatively be active (e.g., powered by an on-board power source, powered by an external power source, such as the air filter system's power source). The short-range communication system can be: NFC, Bluetooth (e.g., Bluetooth Low Energy, Bluetooth Classic, UWB, etc.), Zigbee, or any other suitable short-range communication system.

The short-range communication system is preferably mounted to the frame of the system (e.g., filter frame), but can additionally or alternatively be mounted to the system's packaging, the filter media, and/or to any other suitable portion of the system.

In variants, the system can be packaged for shipping and/or distribution. Examples of the packaging can include: plastic wrap, boxes, and/or any other suitable shipping container. In a specific example, the system can be delivered in a substantially fluidly sealed plastic wrap (e.g., in-situ within the air filter or independently). This plastic wrap can function to prevent contaminant ingress or adsorption into the system prior to use (e.g., thereby prolonging the system's useful lifetime). In variants where the wrapped system is shipped in-situ within the air filter, the wrapping or packaging can preclude filter (or other powered component) electrical connection to the air filter system, and motivate the user to practice filter replacement during setup (e.g., while the user is engaged with the air filter system).

### 4. METHOD

As shown in FIG. 2, the fluid filtration method S200 preferably functions to remove one or more contaminants from a fluid stream (e.g., fluid flow, fluid flow path, fluid path, etc.). The method can include: sorbing contaminants S220, trapping contaminants S240, and/or degrading contaminants S260. The method can optionally include capturing degradation byproducts S280 and/or any other suitable steps and/or processes. The method can be performed by a fluid filtration system (e.g., as described above); however, the method can be performed by any suitable system.

Sorbing the contaminants preferably functions to capture a first subset of contaminants 191 (e.g., molecular contaminants; VOC; contaminants with specific functional groups; contaminants that are smaller than a predetermined size such as 10 nm, 100 nm, 300 nm, 1 μm, etc.; inorganic contaminants such as inorganic material, SOx, NOx, CO, etc.; organic contaminants; etc.) from the fluid flow; however, any suitable contaminants can be sorbed. Sorbing the contaminants can additionally or alternatively function to buffer the flow of contaminants relative to other steps (e.g., store contaminants and release them at a later time), which can enhance the efficiency and/or lifetime of filter media (e.g., specific layers of the filter media such as the reactive layer(s), particle-trapping layer(s), etc.) by not overwhelming the layers with contaminants. Sorbing contaminants can, however, perform any suitable function. Sorbing the contaminants preferably occurs at one or more sorbent layers (e.g. as described above); however, any suitable layer and/or filter can perform the step. Sorbing the contaminants preferably includes adsorbing the contaminants; however, additionally or alternatively, sorbing the contaminants can include reacting with contaminants, absorbing the contaminants, inducing a phase change (e.g., condensation, precipitation, deposition, freezing, etc.), and/or include any suitable process.

Sorbing the contaminants preferably occurs before degrading the contaminants (e.g., contaminant(s) from contaminant-laden fluid are sorbed prior to degradation), and is preferably the first filtering step performed on contaminant-laden fluid; however, sorbing contaminants can occur after degrading the contaminants (e.g., sorb unreacted contaminants, sorb reaction byproducts, etc.), more than once (e.g., prior to and subsequent to degrading the contaminants, etc.), simultaneously with other filtering steps (e.g., sorb contaminants substantially simultaneously with degrading contaminants such as at the same filter layer, sorb contaminants substantially simultaneously with trapping contaminants such as at the same filter layer, etc.), and/or with any suitable timing. However, additionally or alternatively, contaminants can not be sorbed.

Sorbing the contaminants can optionally include releasing the sorbed material (e.g., sorbed contaminants, sorbed byproducts, etc.). Releasing the sorbed material preferably functions to release the sorbed material into the fluid stream, regenerate the sorbent (e.g., prepare and/or return the sorbent to a default condition, prepare the sorbent to sorb material, etc.), and/or perform any suitable function. Releasing the sorbed material can be passive (e.g., occur spontaneously, desorb, etc.) and/or active. In variants where releasing the sorbed material is active, releasing the sorbed material can be performed by a release element and/or by any suitable element. In these variants, releasing the sorbed material can include heating the sorbent, applying an electric field to the sorbent, applying an electric potential to the sorbent, applying force to the sorbent, exposing the sorbent to a vacuum, exposing the sorbent to a recovery material (e.g., a material that can displace the sorbed material), and/or any other suitable mechanism to release sorbed material.

Trapping contaminants preferably functions to trap (e.g., physically capture, chemically capture, etc.) a second subset of contaminants 192 (e.g., contaminants larger than a threshold size such as 0.1 μm, 0.3 μm, 1 μm, 3 μm, 10 μm, 100 μm, etc.). Trapping contaminants can function to decrease the load (e.g., on a reactive filter), extend the lifetime (e.g., of the filter system, of specific filter layers, etc.), change the fluid flow (e.g., rate, pressure drop, etc.) within/through a filter system and/or layer, and/or perform any suitable function. The second subset of contaminants is preferably different from the first subset of contaminants (e.g., those that are sorbed in sorbing the contaminants); however, the first and second subsets of contaminants can overlap, be the same, include any and/or all of the contaminants, and/or have any suitable relationship and/or contaminants.

Trapping the contaminants preferably occurs subsequent to sorbing the contaminants; however, trapping the contaminants can occur at substantially the same time as sorbing the contaminants, before sorbing the contaminants, and/or with any suitable timing. Trapping the contaminants can occur one or more times as fluid flows through the filter media.

Trapping the contaminants is preferably performed by one or more trapping layers (e.g., as described above), more preferably by one or more particle-trapping layers; however, trapping the contaminants can be performed by the sorbing layer and/or by any suitable filter or layer. Trapping the contaminants can be passive (e.g., use a static filter and/or layer) and/or active.

In active variants, trapping the contaminants can include moving a layer and/or component of a layer (e.g., moving fibers from a fibrous filter layer and/or material), electrically charging and/or discharging the layer and/or components of a layer (e.g., charging fibers of a fibrous filter layer), and/or any other suitable step(s). Moving a layer can facilitate fluid flow, enable the layer to cover a larger area, help release particles (e.g., for degradation at a reactive layer), and/or perform any suitable function. Electrically charging a layer can function to electromagnetically trap contaminants (e.g., through electrostatic interactions, through magnetic interactions, etc.), buffer the contaminants (e.g., allow contaminants to be trapped reversibly so that they can be released at a later time), and/or can perform any suitable function. However, any other suitable set of substeps can be performed.

Degrading the contaminants preferably functions to decompose (e.g., oxidize) contaminants into byproducts 197. The byproducts 197 are preferably nontoxic at operational conditions, but can be any suitable set of compounds. The byproducts 197 can depend on the contaminants and can include carbon dioxide (e.g., CO₂), water, carbon monoxide (e.g., CO), sulfur oxides (e.g., SO₂, SO₃, SOₓ, etc.), nitrogen oxides (e.g., NO, NO₂, NOₓ, etc.), phosphorous oxides (e.g., POₓ), boron oxides (e.g., BOA selenium oxides (SeOₓ), arsenic oxides (AsOₓ), hydrogenated and/or protonated oxides, and/or any suitable molecules, atoms, and/or species. In variants, degrading the contaminants can function to remove species from the fluid flow be sequestering them.

Degrading the contaminants preferably happens after trapping contaminants and sorbing contaminants; however, degrading the contaminants can occur before trapping contaminants, before sorbing contaminants, between trapping and sorbing contaminants, and or with any suitable timing. Degrading the contaminants is preferably performed by one or more reactive layers; however, any suitable layer and/or filter can be used.

In variants, for example as shown in FIG. 12, degrading the contaminants can include activating a photocatalytic layer (e.g., with optical illumination, thermal illumination, electrical excitation, etc.), reacting the activated photocatalytic layer with the contaminants to degrade the contaminants, and/or any suitable processes. Activating the photocatalytic layer preferably includes illuminating the photocatalytic layer with light of a suitable wavelength (e.g., matched to the excitation wavelength of the reactive material) to activate the photocatalytic material 116; however, any suitable activation process can be used. Activating the photocatalytic layer can occur continuously and/or intermittently (e.g., with any suitable period, with any suitable timing, in response to a trigger, etc.). Activating the photocatalytic layer is preferably performed by an excitation source (e.g., light source); however, any suitable element can be used. The activated photocatalytic layer can include photocatalytic material in an electronic excited state (e.g., optically excited, thermally excited, etc.), hot (e.g., temperature greater than room temperature) active materials, charged active material (e.g., positively charged, negatively charged, etc.), and/or any suitable activated state.

Reacting the activated photocatalytic layer with contaminants preferably functions to nonspecifically degrade (e.g., oxidize, reduce, etc.) contaminants into byproducts (e.g., oxides of the constituent elements of the contaminant); however, reacting the activated photocatalytic layer with contaminants can perform any suitable function. Reacting the activated photocatalytic layer with contaminants can occur simultaneously with and/or at any suitable time after activating the photocatalytic layer; however, reacting the activated photocatalytic layer with contaminants can occur at any suitable time. Reacting the activated photocatalytic layer with contaminants can include generating radicals (e.g., reactive radicals such as OH) at the activated photocatalyst 116, reacting radicals with the contaminants, direct reaction of the contaminant at the photocatalyst, energy transfer from the photocatalyst to the contaminant (e.g., resonant energy transfer, electron transfer, etc.) to generate activated contaminants, reacting the activated contaminants (e.g., with other contaminants, with other activated contaminants, with other components of the fluid flow, with the photocatalyst, etc.), and/or any other suitable process.

In variants, degrading the contaminants can include chemically reacting with the contaminants. Chemically reacting with the contaminants can function to sequester and remove contaminants from the fluid flow and/or perform any suitable function. Chemically reacting with the contaminants preferably occurs at a reactive layer, more preferably at a chemical layer; however, chemically reacting with the contaminants can occur at any suitable layer and/or filter. In a specific example, chemically reacting with the contaminants can include precipitating a salt of a chemical species (e.g., precipitating a sulfate salt to remove SO₃, a nitrate salt to remove NO₂, etc.). However any suitable chemical reaction can be used.

However, degrading the contaminants can include any suitable processes and/or steps.

The method can optionally include capturing degradation byproducts. Capturing degradation byproducts preferably functions to sequester byproducts (e.g., species that are created after the contaminants have been degraded) to prevent their release into and/or back into the environment. Capturing the degradation byproducts preferably occurs after degrading the contaminants, but can additionally or alternatively occur simultaneously with degrading the contaminants. Capturing the degradation byproducts can be performed by a sorbent layer, reactive layer, particle-trapping layer, any other suitable filter and/or layer, a manifold, a reservoir, and/or any other suitable capture mechanism.

### 5. METHOD OF MANUFACTURE

As shown in FIG. 3, a method of manufacture S300 for the filter media can include: applying materials to a filter layer S320, combining a plurality of filter layers into the filter media S350 (combining a plurality of layers), and conferring a structural form to the filter media S370. The method of manufacture can additionally or alternatively include any other suitable steps and/or subprocesses.

The method of manufacture can include Block S320, which includes applying materials to a filter layer. Block S320 functions to functionalize a layer (e.g., a substrate) in cases wherein the desired function of the layer is related to contaminant removal mechanisms in addition to mechanical filtration (e.g., sorption, degradation, active trapping, etc.). Applying materials to a filter layer preferably occurs prior to combining a plurality of layers into the filter media; however, applying materials to a filter layer can occur simultaneously with combining a plurality of layers and/or with any suitable timing. Applying materials to a filter layer can occur one or more times as necessary (e.g., to the same substrate, to different substrates, to the same layer, to different layers, etc.) to get ensure appropriate coverage and/or layer thickness. Applying materials to a filter layer can include applying one or more active layers to one or more substrates. In a specific example, photocatalytic nanoparticles can be applied to one substrate to form a reactive layer and activated carbon pellets can be applied to a scrim 132 (e.g., substrate) to form a sorbent layer. In another specific example, photocatalytic nanoparticles and activated carbon can each be applied to a substrate to form a reactive and sorbent layer in the substantially same layer. However, any suitable material can be applied to any suitable layer.

Block S320 can be performed utilizing any suitable manufacturing process for applying material (e.g., particulate material, coatings, photocatalytic material, photocatalytic nanoparticles, activated carbon, fibers, etc.) to a substrate (e.g., a fabric substrate, a sheet of any other suitable material, etc.). For example, Block S320 can include spray coating, electrostatic coating in combination with pressed-bonding, dip coating, dropcasting, spin coating, evaporation, directed synthesis (e.g., directly growing material on the substrate), waving, pressing, and/or any other suitable process.

For example, Block S320 can include applying photocatalytic nanoparticles to a fabric substrate of a filter layer. In another example, Block S320 can include applying activated carbon particles to a substrate (e.g., scrim 132) of a trapping layer. In another example, Block S320 can include applying chargeable (e.g., dielectric, metallic, etc.) particles to a substrate (e.g., to facilitate electrostatic charging of filter layer). Block S320 can additionally or alternatively include combining conductive fibers with one or more layers of the filter media (e.g., by pressing conductive fibers into a felt, weaving conductive fibers into a woven fabric, etc.).

Additionally or alternatively, Block S320 can include applying any suitable material to a filter layer in any other suitable manner.

Block S350 can include combining a plurality of filter layers into a filter media. Block S350 can function to create a filter media that can remove multiple types of contaminants by way of various contaminant removal mechanisms (e.g. as described above in relation to the system 100). Block S350 preferably occurs after Block S320; however, Block S350 can occur simultaneously with and/or prior to Block S320. Block S350 preferably forms a layer stack in the filter media that is in a specified (e.g., predetermined) order (e.g., preferred layer order, preferred layer orientation, etc.); however, the layer stack can be prepared in any order. Block S350 can be repeated one or more times to prepare the filter media. In a specific example, Block S350 can be repeated separately to build a filter media one layer at a time (e.g., combine two layers before adding a third layer). In another specific example, Block S350 can include combining more than two layers together at the same time. However, Block S350 can be repeated as necessary to manufacture a filter media.

Block S350, combining a plurality of filter layers into a filter media can include adhering (e.g., using inorganic binder, organic binder, etc.), bonding (e.g., covalent bond, ionic bond, metallic bond, van der Waals bond, etc.), rolling, crimping, entangling, soldering, weaving, agitating, etc. one or more layers together. Block S350 can include any suitable combination of one or more techniques applied to combine layers.

In a specific example, Block S350 includes placing a fabric sorbent layer adjacent to a metallic mesh (e.g., aluminum, steel, any other suitable metallic material, etc.) at a first side and a reactive layer (e.g., impregnated with photocatalytic material for performance of PECO processes) adjacent to the metallic mesh at a second side opposing the first side. In this example, Block S350 includes pressing the three layers (e.g., the sorbent layer, the metallic mesh layer, and the reactive layer) together using opposing rollers to apply a predetermined transverse pressure force to bond the three layers into a filter media.

In another specific example, Block S350 can include placing an adhesive on a first side of a reactive layer with a metallic mesh adjacent to the reactive layer on the same side. In this example, the metallic mesh can be brought into contact with the adhesive. The adhesive can be allowed to dry in order for the metallic mesh (e.g., support layer) to be bonded to the reactive layer. However, any suitable mechanism for combining the layers can be used.

In variations, Block S350 can include bonding two or more fibrous layers (e.g., felt fabric layers functionalized to perform sorption and/or degradation functions, chargeable felt fabric layers that can be electrostatically charged to perform particle trapping, etc.) via fibrous entanglement. For example, two fibrous layers can be placed adjacent to one another and agitated such that surface fibers are freed from the felt of their respective layer and entangled with the surface fibers of the adjacent fibrous material.

Additionally or alternatively, Block S350 can include bonding two or more layers together in any suitable manner to form a filter media.

Block S370 can include conferring a structural form to the filter media. Block S370 can function to confer the filter media with the desired structure (e.g., shape, geometry, form factor, etc.). Block S370 preferably occurs after Block S350; however, Block S370 can occur prior to Block S350. Block S370 can be repeated one or more times to prepare the filter media. In a specific example, Block S370 can be repeated separately to layer of the filter media prior to Block S350 (e.g., pleat each layer individual prior to combining the layers). In another specific example, Block S370 can include shaping the filter media that has already been combined (e.g., after Block S350) to confer a structure to the entire filter media at once. However, Block S370 can be repeated as necessary to manufacture a filter media.

Block S370 can include creating a form factor and/or creating a broad face structure (e.g., pleated, smooth, folded, ridged, puckered, curved, etc.). Block S370 can include folding, bending, cutting, adhering, bonding, pressing, molding, and/or any other suitable process or combination of processes.

Additionally or alternatively, Block S370 can include manipulating one or more layers in any suitable manner to shape the layers of the filter media.

### 6. SPECIFIC EXAMPLES

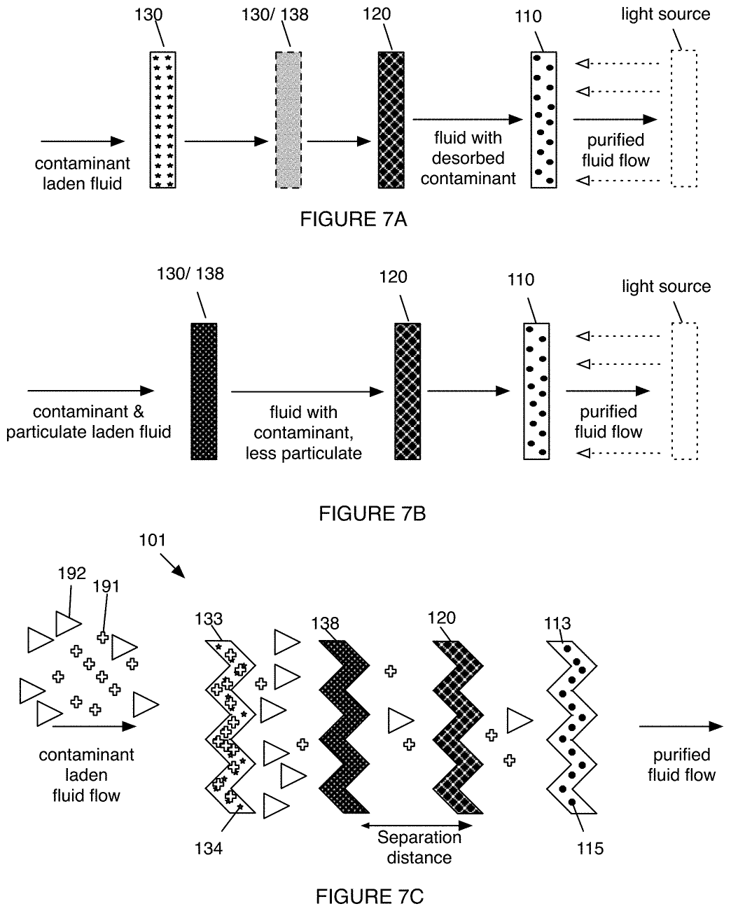

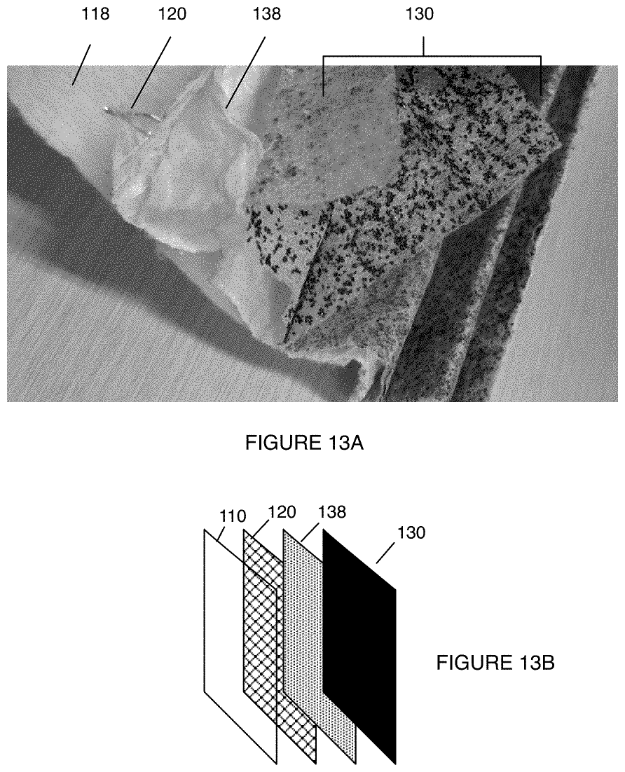

In a first specific example, (illustrative examples shown in FIG. 7C, FIG. 13A, and FIG. 13B), a multilayer filter (e.g., filter media) can include, in series: a sorbent layer, a particle-trapping layer, a support layer, and a reactive layer. In this example, the fluid flow direction is such that the fluid interacts first with the sorbent layer, then the particle trapping layer, then the support layer, and finally the photocatalytic layer. In this example, the sorbent layer can include activated carbon pellets, the particle trapping layer can be a fabric with a MERV rating of 16, the support layer can be a hexagonal metallic mesh (e.g., aluminium), and the reactive layer can be a photocatalytic layer (e.g., a nanoparticle active layer disposed on a fibrous substrate that meets MERV 9 standard or better). In this example, the each of the layers of the filter media can have a separation distance between adjacent layers. A light source can be arranged adjacent to the photocatalytic layer and configured to illuminate the photocatalytic layer. All of the layers can be held together in the same frame.

In a second specific example, as shown in FIG. 10, a multilayer filter (e.g., filter media) can include, in series: a sorbent layer, a particle-trapping layer, a support layer, a primary reactive layer, and a secondary reactive layer. In this example, the fluid flow direction is such that the fluid interacts first with the sorbent layer, then the particle trapping layer, then the support layer, the primary reactive layer, and then the secondary reactive layer. In this example, the sorbent layer can include activated carbon pellets disposed between two scrim layers (e.g., where the scrim layers can be optically opaque such as black), the particle trapping layer can be a fabric with a MERV rating of 16, the support layer can be a hexagonal metallic mesh (e.g., steel), the primary reactive layer can be a photocatalytic layer (e.g., a nanoparticle active layer disposed on a fibrous substrate that meets MERV 9 standard or better), and the secondary reactive layer can be a barium hydroxide solution.

In a third specific example, a multilayer filter (e.g., filter media) can include, in series: a sorbent layer, a particle-trapping layer, and a reactive layer. In this example, the fluid flow direction is such that the fluid interacts first with the sorbent layer, then the particle trapping layer, and finally the reactive layer. In this example, the sorbent layer can include activated carbon pellets, the particle trapping layer can be a fabric with a MERV rating of 16, and the reactive layer can be a photocatalytic layer (e.g., photocatalytic nanoparticles disposed on a substrate that meets MERV 9 standard). In this specific example, the photocatalytic layer substrate can be loaded with metallic rods (e.g., aluminium) to enhance the strength of the photocatalytic layer. The metallic rods are preferably conductive (e.g., electrically), however the rods can be nonconductive.

In a fourth specific example, a multilayer filter (e.g., filter media) can include, in series: a sorbent layer, a support layer, and a reactive layer (example shown in FIG. 7A, with an optional particle-trapping layer). In this example, the fluid flow direction is such that the fluid interacts first with the sorbent layer, then the support layer, and finally the reactive layer. In this example, the sorbent layer can include activated carbon pellets, the support layer can be a metallic mesh (e.g., aluminium), and the reactive layer can be a photocatalytic layer (e.g., photocatalytic nanoparticles disposed on a substrate that meets MERV 12+ standard).

In a fifth specific example, a multilayer filter (e.g., filter media) can include, in series: a trapping layer, a support layer, and a reactive layer (example shown in FIG. 7B). In this example, the fluid flow direction is such that the fluid interacts first with the trapping layer, then the support layer, and finally the reactive layer. In this example, the trapping layer can be a fabric with a MERV rating of 12 or higher, the support layer can be a hexagonal mesh including aluminium, and the reactive layer can be a photocatalytic layer (e.g., photocatalytic nanoparticles disposed on a substrate). A light source can be arranged adjacent to the photocatalytic layer and configured to illuminate the photocatalytic layer. In this specific example, the trapping layer is preferably configured to reflect optical radiation (e.g., be made of a reflective material, be coated with a reflective material, have a porosity suitable to reflection of light, etc.); however the trapping layer can have any suitable optical properties.

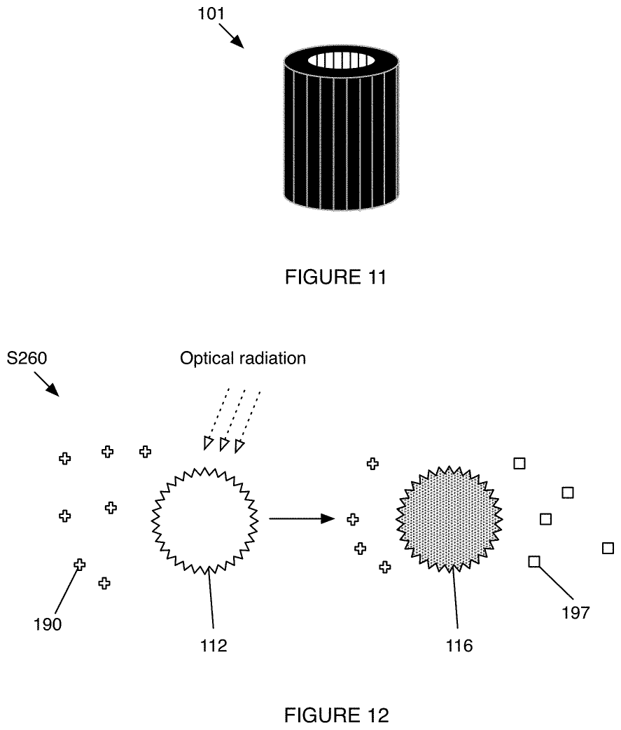

In a sixth specific example, a multilayer filter (e.g., filter media) can be cylindrical (examples shown in FIG. 5, FIG. 11, FIG. 14, and FIG. 15). The filter media can include, in series: a sorbent layer, a particle-trapping layer, a support layer, and a reactive layer. In this example, the fluid flow direction is radial inward, such that the fluid interacts first with the sorbent layer, then the particle trapping layer, then the support layer, and finally the photocatalytic layer. In this example, the sorbent layer can include activated carbon pellets, the particle trapping layer can be a fabric with a MERV rating of 14 or higher (and/or have a dust holding capacity of 5 g or higher), the support layer can be a hexagonal metallic mesh (e.g., aluminium), and the reactive layer can be a photocatalytic layer (e.g., a nanoparticle active layer disposed on a fibrous substrate that meets MERV 9 standard). A light source can be arranged adjacent to the photocatalytic layer and configured to illuminate the photocatalytic layer. All of the layers can be held together in the same frame, where the frame can include two subframes that can attach to a top and bottom of the filter media. The filter media can be installed within a fluid purification unit including a lumen and an impeller module (e.g., a fan), configured to control a fluid path. The fluid path can be controlled such that contaminant-laden air enters the filter media radially and the purified air is expelled axially. In an illustrative example of this example, the multilayer filter can have a 6 inch outer diameter, 30.8 inch inner diameter, a 6.5 inch height, have a pleat density of 5 or more pleats per 100 mm, and/or have 75 pleats. However, this example can be otherwise configured.

In a seventh specific example, a multilayer filter (e.g., filter media) can be box shaped (for example, as shown in FIG. 4). The filter media can include, in series: a sorbent layer, a particle-trapping layer, a support layer, and a reactive layer. In this example, the fluid flow direction is substantially perpendicular to a broad face of the box, such that the fluid interacts first with the sorbent layer, then the particle trapping layer, then the support layer, and finally the photocatalytic layer. In this example, the sorbent layer can include activated carbon pellets, the particle trapping layer can be a fabric with a MERV rating of 12 or higher, the support layer can be a hexagonal metallic mesh (e.g., aluminium), and the reactive layer can be a photocatalytic layer (e.g., a nanoparticle active layer disposed on a fibrous substrate that meets MERV 9 standard). A light source can be arranged adjacent to the photocatalytic layer and configured to illuminate the photocatalytic layer. All of the layers can be held together in the same frame, where the frame can surround the edge of the filter media. The filter media can be installed within a fluid purification unit including a lumen and an impeller module (e.g., a fan), configured to control a fluid path. The fluid path can be controlled such that contaminant-laden air enters the filter media from one side and the purified air is expelled from the opposing side.

In an eighth specific example, the method of purifying a fluid can include sorbing a subset of contaminants from the fluid flow, trapping a second subset of contaminants from the fluid flow, and degrading contaminants in the fluid flow. Sorbing the subset of contaminants preferably buffers the rate and quantity of contaminants (e.g., molecular contaminants such as VOCs, inorganic, etc.) to be degraded at once and preferably occurs at an active carbon layer (e.g., sorbing layer). Trapping a second subset of contaminants preferably functions to capture contaminants based on the contaminant size (e.g., larger than 0.3 μm, and/or any suitable size) and preferably occurs at a particle-trapping layer (e.g., with MERV rating greater than 12). Degrading the contaminants preferably includes illuminating a photocatalytic layer, generating reactive radicals, and reacting the radicals with contaminants, and preferably occurs at a photocatalytic layer. This specific example can optionally include capturing the reaction byproducts to prevent the release of the byproducts into the external environment, and preferably occurs at a sorbing layer or a reactive layer. However, any suitable processes can be included and all processes can occur at any suitable layer and/or filter.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. An air filtration system, comprising:
a reactive layer, wherein the reactive layer is configured to react with contaminants in air;
a particle-trapping layer, wherein the particle-trapping layer is configured to trap a subset of the contaminants in the air, wherein the particle-trapping layer is upstream of and in contact with the reactive layer;
a sorbent layer, wherein the sorbent layer is configured to sorb a second subset of the contaminants in the air, wherein the sorbent layer is upstream of and in contact with the particle-trapping layer; and
a frame, wherein the reactive layer, the particle-trapping layer, and the sorbent layer are connected to the frame.

2. The air filtration system of claim 1, wherein the reactive layer comprises a substrate layer comprising a fibrous material and a photoelectrochemical oxidation (PECO) layer, wherein the PECO layer comprises photocatalytic nanostructures.

3. The air filtration system of claim 2, further comprising a support layer, wherein the support layer is electrically conductive, and wherein the PECO layer is coupled to the support layer.

4. The air filtration system of claim 1, further comprising a second reactive layer, wherein the second reactive layer is downstream of the reactive layer, wherein the second reactive layer is configured to react with byproducts after the reactive layer reacts with the contaminants in the air, wherein the second reactive layer does not comprise photocatalytic material.

5. The air filtration system of claim 1, further comprising a second reactive layer, wherein the second reactive layer is configured to react with inorganic contaminants in the air.

6. The air filtration system of claim 1, further comprising a support layer, wherein the support layer is upstream of the reactive layer, wherein the support layer is configured to provide structural support for the air filtration system, and wherein the support layer comprises a metallic mesh.

7. The air filtration system of claim 1, wherein the sorbent layer comprises activated carbon, wherein the activated carbon is configured to adsorb the second subset of contaminants from the air.

8. The air filtration system of claim 1, wherein the sorbent layer is optically opaque.

9. The air filtration system of claim 7, wherein the sorbent layer further comprises a first scrim layer and a second scrim layer, wherein the sorbent layer forms a structure wherein the activated carbon is located between the first and the second scrim layer.

10. The air filtration system of claim 1, wherein the subset of contaminants from the air comprises inorganic contaminants.

11. The air filtration system of claim 1, wherein the particle-trapping layer meets at least MERV 12 standard.

12. The air filtration system of claim 11, wherein the particle-trapping layer is a passive, mechanical filter.

13. The air filtration system of claim 1, wherein the particle-trapping layer comprises a reflective material.

14. The air filtration system of claim 1, wherein the reactive layer comprises a photocatalytic material, wherein a degradation efficiency of the reactive layer is enhanced by the particle-trapping layer.

15. A method for removing contaminants from a fluid, comprising:
sorbing a first subset of the contaminants from the fluid at a sorbent layer;
after sorbing the first subset of the contaminants, trapping a second subset of the contaminants from the fluid at a particle-trapping layer;
illuminating a photocatalytic layer with optical radiation to generate an activated photocatalytic layer;
after trapping the second subset of the contaminants, reacting a third subset of the contaminants proximal the activated photocatalytic layer; and
releasing byproducts produced from the reaction between the third subset of the contaminants and the activated photocatalytic layer;
wherein the sorbent layer is in contact with and upstream of the particle-trapping layer relative to a fluid flow direction, and wherein the particle-trapping layer is in contact with and upstream of the photocatalytic layer relative to the fluid flow direction.

16. The method of claim 15, wherein releasing the byproducts from the reaction further comprises capturing the byproducts.

17. The method of claim 15, wherein the sorbent layer comprises activated carbon and wherein sorbing the first subset of the contaminants comprises reversibly adsorbing the first subset of the contaminants.

18. The method of claim 15, wherein the particle-trapping layer at least meets MERV 12 standard.

19. The method of claim 15, wherein the photocatalytic layer, the particle-trapping layer, and the sorbent layer are coupled to a frame.

20. The method of claim 15, wherein illuminating the photocatalytic layer comprises illuminating the photocatalytic layer with a light source, wherein the optical radiation emitted by the light source has a minimum wavelength greater than 280 nanometers.

21. The method of claim 15, where in the photocatalytic layer comprises a substrate layer, wherein the substrate layer comprises a fibrous material, and a photoelectrochemical oxidation (PECO) layer, and wherein the PECO layer comprises photocatalytic nanostructures.

22. The method of claim 21, wherein reacting the contaminants at the activated photocatalytic layer further comprises:
generating radicals at the PECO layer; and
reacting the radicals with the contaminants.

23. The method as claimed in claim 15, wherein a degradation efficiency of the photocatalytic layer is enhanced by the particle-trapping layer.
